(19) United States
(12) Patent Application Publication
(10) Pub. No.: US 2025/0076454 A1
(43) Pub. Date: Mar. 6, 2025

(54) RADAR APPARATUS, RADAR SIGNAL GENERATION CIRCUITRY, AND TRANSMISSION METHOD

(71) Applicant: Panasonic Automotive Systems Co., Ltd., Kanagawa (JP)

(72) Inventor: Takaaki KISHIGAMI, Tokyo (JP)

(21) Appl. No.: 18/814,169

(22) Filed: Aug. 23, 2024

(30) Foreign Application Priority Data
Aug. 28, 2023 (JP) 2023-138294

(51) Int. Cl. G01S 7/282; G01S 7/02; G01S 7/285; G01S 13/10

(52) U.S. Cl. CPC G01S 7/282; G01S 7/0232; G01S 7/285; G01S 13/106

(57) ABSTRACT

A radar apparatus includes: first radar circuitry, which, in operation, transmits a first transmission signal; and second radar circuitry, which, in operation, transmits a second transmission signal; in which a plurality of transmission periods in which the first transmission signal and the second transmission signal are transmitted include a first transmission period in which frequency-division multiplexing transmission of the first transmission signal and the second transmission signal is performed, and a second transmission period in which the first transmission signal and the second transmission signal are transmitted at a same frequency.

### TECHNICAL FIELD

The present disclosure relates to a radar apparatus, radar signal generation circuitry, and a transmission method.

### BACKGROUND ART

Recently, studies have been developed on radar apparatuses that use a radar transmission signal (hereinafter, referred to as “TxSig”) of a short wavelength including a microwave or a millimeter wave that can achieve high resolution. Further, there has been a proposed radar apparatus, for example, in which a transmitter in addition to a receiver is provided with a plurality of antennas (array antenna), and which is configured to perform beam scanning through signal processing using the transmission and reception array antennas (which may also be referred to as a Multiple Input Multiple Output (MIMO) radar) (e.g., see Non-Patent Literature (hereinafter referred to as “NPL”) 1).

### CITATION LIST

### Patent Literature

PTL 1
U.S. Patent Application Publication No. 2020/0300965
PTL 2
WO2023/074275
PTL 3
Japanese Patent Application Laid-Open No. 2020-148754
PTL 4
Japanese Patent Application Laid-Open No. 2020-204603

### Non-Patent Literature

NPL 1
J. Li, and P. Stoica, “MIMO Radar with Colocated Antennas,” Signal Processing Magazine, IEEE Vol. 24, Issue: 5, pp. 106-114, 2007
NPL 2
E. Fishler, A. Haimovich, R. Blum, D. Chizhik, L. Cimini and R. Valenzuela, “MIMO radar: an idea whose time has come,” Proceedings of the 2004 IEEE Radar Conference, 2004, pp. 71-78
NPL 3
M. Kronauge, H. Rohling, “Fast two-dimensional CFAR procedure,” IEEE Trans. Aerosp. Electron. Syst., 2013, 49, (3), pp. 1817-1823
NPL 4
Direction-of-arrival estimation using signal subspace modeling Cadzow, J. A.; Aerospace and Electronic Systems, IEEE Transactions on Volume: 28, Issue: 1 Publication Year: 1992, Page(s): 64-79
NPL 5
H. Yan, J. Li and G. Liao, “Multitarget Identification and Localization Using Bistatic MIMO Radar Systems,” EURASIP Journal on Advances In Signal Processing, vol. 2008, Article ID 283483, 8 pages, 2008.

### SUMMARY OF INVENTION

However, methods for a radar apparatus (e.g., MIMO radar) to sense a target object (or a target) have not been comprehensively studied.

One non-limiting and exemplary embodiment of the present disclosure facilitates providing a radar apparatus, radar signal generation circuitry, and a transmission method capable of efficiently detecting a target object.

A radar apparatus according to one exemplary embodiment of the present disclosure includes: first radar circuitry, which, in operation, transmits a first transmission signal; and second radar circuitry, which, in operation, transmits a second transmission signal; in which a plurality of transmission periods in which the first transmission signal and the second transmission signal are transmitted include a first transmission period in which frequency-division multiplexing transmission of the first transmission signal and the second transmission signal is performed, and a second transmission period in which the first transmission signal and the second transmission signal are transmitted at a same frequency.

Note that these generic or specific exemplary embodiments may be achieved by a system, an apparatus, a method, an integrated circuit, a computer program, or a recoding medium, and also by any combination of the system, the apparatus, the method, the integrated circuit, the computer program, and the recoding medium.

According to one exemplary embodiment of the present disclosure, a radar apparatus is capable of efficiently detecting a target object.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an example of a radar apparatus having a mono- & multi-static configuration;

FIG. 2 is a block diagram illustrating an exemplary configuration of a radar apparatus;

FIG. 3 is a block diagram illustrating an exemplary configuration of the radar apparatus;

FIG. 4 illustrates an example of a transmission signal;

FIG. 5 illustrates an example of a chirp signal;

FIG. 6 illustrates an example of Doppler multiplexing transmission;

FIG. 7 illustrates an example of Doppler multiplexing transmission;

FIG. 8 illustrates an example of Doppler multiplexing transmission;

FIG. 9 illustrates an example of Doppler multiplexing transmission;

FIG. 10 illustrates an example of Doppler multiplexing transmission;

FIG. 11 illustrates an example of Doppler multiplexing transmission;

FIG. 12 illustrates an example of Doppler multiplexing transmission;

FIG. 13 illustrates an example of Doppler multiplexing transmission;

FIG. 14 illustrates an example of a reception Doppler at the time of Doppler multiplexing transmission;

FIG. 15 illustrates an example of a transmission signal;

FIG. 16 is a block diagram illustrating an exemplary configuration of a receiver of the radar apparatus;

FIG. 17 illustrates an example of a transmission signal;

FIG. 18 is a block diagram illustrating an exemplary configuration of the receiver of the radar apparatus;

FIG. 19 illustrates an example of a transmission signal;

FIG. 20 is a block diagram illustrating an exemplary configuration of the receiver of the radar apparatus;

FIG. 21 is a block diagram illustrating an exemplary configuration of a part of a radar apparatus;

FIG. 22 illustrates an example of a transmission signal;

FIG. 23 illustrates an example of a transmission signal; and

FIG. 24 illustrates an example of a transmission signal.

### DESCRIPTION OF EMBODIMENTS

MIMO radars are roughly divided into, for example, a “monostatic configuration” and a bistatic configuration or a multistatic configuration (hereinafter, referred to as a “bistatic/multistatic configuration”). Hereinafter, the monostatic configuration is referred to as a “MNS configuration,” and the bistatic/multistatic configuration is referred to as a “BMS configuration.”

The MNS configuration may, for example, be a configuration in which a transmitter (for example, including a plurality of transmission antennas and a high-frequency radio) and a receiver (for example, including a plurality of reception antennas and a high-frequency radio) are included in the same housing.

In the BMS configuration, for example, the transmitter and the receiver may be included respectively in different housings. For example, the BMS configuration is a configuration in which the housings are installed at distances apart from each other, and the transmitter and the receiver are connected to a controller that performs synchronization control. In the bistatic configuration, for example, a pair of the transmitter and the receiver is provided, and the transmitter and the receiver are disposed at distances apart from each other. The multistatic configuration is, for example, a configuration in which at least one or both of the transmitter and the receiver are plural. The multistatic configuration is disclosed in, for example, NPL 2.

In the following, a non-limiting exemplary embodiment of the present disclosure focuses on the BMS configuration. For example, in the non-limiting exemplary embodiment, the BMS configuration using a plurality of MIMO radars having the MNS configuration will be described. The BMS configuration using a plurality of MIMO radars having the MNS configuration may be referred to as a “mono- & multi-static configuration,” for example.

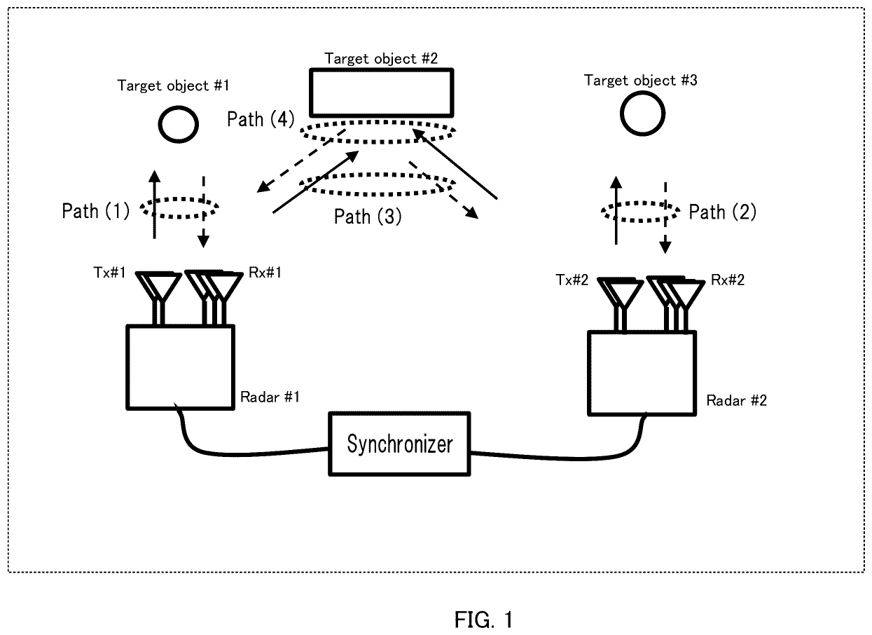

FIG. 1 illustrates an exemplary radar apparatus having the mono- & multi-static configuration in which radar #1 and radar #2 being MIMO radars having the MNS configuration are used.

Radar #1 is, for example, a “first MIMO radar having the MNS configuration” that outputs a radar transmission wave (also referred to as “TxSig”) from radar transmission antenna group Tx #1 and receives a reflected wave signal from target object #1 by radar reception antenna group Rx #1 in the same housing (for example, path (1)).

Similarly, radar #2 is, for example, a “second MIMO radar having the MNS configuration” that outputs a radar transmission wave from radar transmission antenna group Tx #2 and receives a reflected wave signal from target object #3 by radar reception antenna group Rx #2 in the same housing (for example, path (2)).

Further, the radar apparatus illustrated in FIG. 1 may also perform an operation of transmitting a radar transmission wave from transmission antenna group Tx #1 of radar #1 and receiving a reflected wave signal from target object #2 by reception antenna group Rx #2 of radar #2. The radar apparatus performing this operation may be regarded as, for example, a “first MIMO radar having the BMS configuration” (for example, path (3)).

Similarly, the radar apparatus illustrated in FIG. 1 may also perform an operation of transmitting a radar transmission wave from transmission antenna group Tx #2 of radar #2 and receiving a reflected wave signal from target object #2 at the reception antenna group Rx #1 of radar #1. The radar apparatus performing this operation may be regarded as, for example, a “MIMO radar having a second BMS configuration” (for example, path (4)).

For using a radar not only as the radar having the MNS configuration, but also as the radar having the BMS configuration, a synchronizer that performs synchronization control between a plurality of radars having the MNS configuration installed at distant positions may, for example, be used. For example, in FIG. 1, when a Frequency modulated continuous wave (FMCW) signal (for example, a “chirp signal”) is used as the radar transmission wave, the synchronizer may generate the chirp signal and supply a common chirp signal to radar #1 and radar #2. Thus, such a radar can be used as the first MIMO radar having the MNS configuration and the second MIMO radar having the MNS configuration, and can also be used as the first MIMO radar having the BMS configuration and the second MIMO radar having the BMS configuration.

The synchronizer may generate a plurality of different chirp signals and supply the different chirp signals to each of radar #1 and radar #2. However, when a plurality of different chirp signals whose center frequencies have a frequency difference such that the center frequencies fall out of reception bands of radar #1 and radar #2 are transmitted, it is difficult to use such a radar as the first and second MIMO radars having the BMS configuration.

The radar apparatus illustrated in FIG. 1 may generate TxSig in the synchronizer and provide TxSig to both radar #1 and radar #2.

For example, when the first and second radars of the MNS configuration operate at the same time using the same radar transmission wave, interference may occur with each other, so that erroneous detection or missed detection may easily occur, and the positioning accuracy or the detection performance of the radar may deteriorate. Therefore, for example, for the transmission by the radars having the BMS configuration using the first and second radars having the MNS configuration, there may be application of multiplexing transmission in which Time Division Multiplexing (TDM), Frequency Division Multiplexing (FDM), or Code Division Multiplexing (CDM) is applied.

Regarding the transmission of the radar having the BMS configuration, for example, PTL 1 or 2 discloses the application of time-division and frequency-division multiplexing transmission, and assumes the following cases.

In the time-division multiplexing transmission in the BMS configuration, for example, the transmission from radar #1 to radar #2 in the BMS configuration is completed, and then the transmission is switched to the transmission from radar #2 to radar #1 in the BMS configuration. Thus, the time required for the transmission processes of both the MNS configuration and the BMS configuration is likely to increase, and the tracking performance during movement of the target is likely to deteriorate. Further, for example, when the time-division multiplexing transmission of radar #1 and radar #2 is performed in transmission periods (Tr) of the chirp signals, the radar apparatus illustrated in FIG. 1 performs Doppler frequency analysis of reflected wave signals every two transmission periods (2Tr) of the chirp signals. Accordingly, a detectable maximum Doppler is likely to decrease, and the range of the Doppler frequency is reduced to ±1/(4Tr). In the following description, the Doppler frequency is also referred to as “DFreq.”

Further, for example, when frequency multiplexing transmission in the BMS configuration is performed (for example, the chirp signals are transmitted with such a frequency difference that the frequencies fall outside the reception bands of radar #1 and radar #2), and all the reception antennas of radar #1 or radar #2 perform reception processing for the transmission antennas of the corresponding radar, reception in the first and second BMS configurations is difficult. On the other hand, for example, in a case where a part of the reception antennas of radar #1 or radar #2 performs the reception processing on a transmission signal having a frequency different from the transmission signal of the corresponding radar, the number of reception antennas that receive the reflected wave signal from the transmission signal of the radar decreases. Therefore, in the radar apparatus illustrated in FIG. 1, the reception signal level is likely to be lowered or the angle measurement accuracy is likely to be deteriorated.

In a non-limiting exemplary embodiment of the present disclosure, a method for improving the efficiency of target detection in the mono- & multi-static configuration is described. For example, the non-limiting exemplary embodiment of the present disclosure describes a multiplexing transmission method that maintains radar detection performance (e.g., detectable DFreq range) in the MNS configuration, and enables simultaneous multiplexing transmission not only in the MNS configuration but also in the BMS configuration, to reduce the time required for radar distance measurement.

For example, in a non-limiting exemplary embodiment of the present disclosure, in addition to radar positioning with the MNS configuration of radar #1 and radar #2 illustrated in FIG. 1, radar positioning with the BMS configuration from radar #1 to radar #2 and radar positioning with the BMS configuration from radar #2 to radar #1 may be performed simultaneously.

For example, as the multiplexing transmission in the BMS configuration, frequency division multiplexing (FDM) transmission and the same-frequency transmission may be alternately applied at a predetermined cycle (hereinafter, such transmission may also be referred to as “inter-BMS partial frequency-division multiplexing (P-FDM) transmission”).

Further, for example, all the reception antennas of radar #1 or radar #2 may perform reception processing for the transmission antennas of the corresponding radar.

Note that the radar apparatus according to an exemplary embodiment of the present disclosure may be mounted on a mobile entity such as a vehicle, for example. For example, the radar apparatus may be mounted near at least one of the front and rear corners of a vehicle, or may be mounted near at least one of the front and rear centers of the vehicle or near corners from the centers.

A positioning output (information on an estimation result) of the radar apparatus mounted on a mobile entity may be output to, for example, an Advanced Driver Assistance System (ADAS) that enhances collision safety or a control Electronic Control Unit (ECU) (not illustrated) such as an automated driving system, and may be used for vehicle-drive control or alarm call control.

In addition, the radar apparatus according to one exemplary embodiment of the present disclosure may be attached to a relatively high-altitude structure, such as, for example, a roadside utility pole or traffic lights. Such a radar apparatus can be utilized, for example, as a sensor of a support system for enhancing the safety of passing vehicles or pedestrians, or a suspicious person intrusion prevention system. Further, the positioning output of the radar apparatus may be output to, for example, a control apparatus (not illustrated) in the support system for enhancing the safety or the suspicious person intrusion prevention system, and may be used for alarm call control or abnormality detection control.

The use of the radar apparatus is not limited to the above, and the radar apparatus may also be used for other uses.

Further, the target object is an object to be detected by the radar apparatus, and includes, for example, a vehicle (including four wheels and two wheels), a person, a block, a curbstone, or the like.

Embodiments according to exemplary embodiments of the present disclosure will be described below in detail with reference to the accompanying drawings. In the embodiments, the same constituent elements are identified with the same numerals, and a description thereof is omitted because of redundancy.

The following describes a configuration of a radar apparatus (for example, MIMO radar configuration) having a transmitting branch in which multiplexed different transmission signals are simultaneously sent from a plurality of transmission antennas, and a receiving branch in which the transmission signals are separated and subjected to reception processing.

Further, by way of example, a description will be given below of a configuration of a radar system using a frequency-modulated pulse wave such as a chirp pulse (e.g., also referred to as chirp pulse transmission (fast chirp modulation)). However, the modulation scheme is not limited to frequency modulation. For example, an exemplary embodiment of the present disclosure is also applicable to a radar system that uses a pulse compression radar configured to transmit a pulse train after performing phase modulation or amplitude modulation on the pulse train.

### EMBODIMENTS

### [Configuration of Radar Apparatus]

The radar apparatus (or radar system) according to the present embodiment may include, for example, a plurality of radar sections (which corresponds to radar circuitry and is, for example, a MIMO radar). Further, the radar apparatus according to the present embodiment may include, for example, a synchronizer (for example, corresponding to control circuitry) that performs synchronization control between a plurality of radar sections, and a positioning output integrator that integrates positioning outputs of the plurality of radar sections.

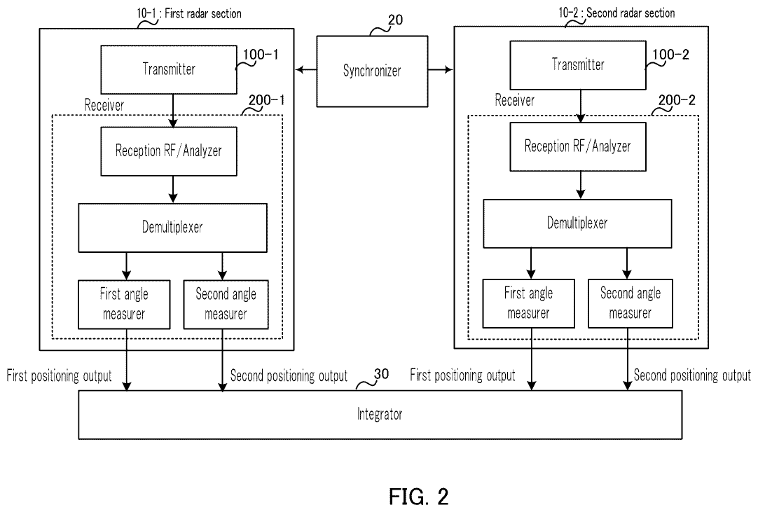

For example, radar apparatus 1 illustrated in FIG. 2 is a radar system including first radar section 10 (or expressed by radar section 10-1) having a plurality of transmission/reception antennas (not illustrated), and second radar section 10 (or expressed by radar section 10-2) having a plurality of transmission/reception antennas (not illustrated).

In radar apparatus 1 illustrated in FIG. 2, synchronizer 20 performs synchronization control between first radar section 10 and second radar section 10. For example, synchronizer 20 may generate a chirp signal or a reference clock signal (also referred to as a reference signal) as a synchronization control signal to first radar section 10 and second radar section 10 for synchronization control.

Here, the reference signal is, for example, a reference signal of a Voltage Controlled Oscillator (VCO) that generates a chirp signal, and is a high-frequency signal of about several tens to several hundreds MHz. In the case where synchronizer 20 uses the reference signal as the synchronization control signal, a system cost can be lowered as compared with the case where the chirp signal (for example, GHz order) is used. Note that, in the case where synchronizer 20 uses the reference signal, the chirp signal is generated individually in each of first radar section 10 and second radar section 10. Thus, the coherence of the phases between first radar section 10 and second radar section 10 is not guaranteed, and the phase shift to such an extent as to drift to cause displacement is likely to occur. For example, radar apparatus 1 may measure and correct a drift component of the phase between first radar section 10 and second radar section 10 in advance.

For example, radar apparatus 1 may transmit a transmission signal from a plurality of transmission antennas of transmitter 100-1 of first radar section 10. Radar apparatus 1 may perform positioning processing of target object #1, for example, by receiving a reflected wave signal by receiver 200-1 having a plurality of reception antennas of first radar section 10, the reflected wave signal being the transmission signal of first radar section 10 reflected by target object #1 (corresponding to target object #1 in FIG. 1) (for example, radar positioning using the MNS configuration).

Further, radar apparatus 1 may perform positioning processing of target object #2, for example, by receiving a reflected wave signal by receiver 200-2 having a plurality of reception antennas of second radar section 10, the reflected wave signal being the transmission signal of first radar section 10 reflected by target object #2 (corresponding to target object #2 in FIG. 1) (for example, radar positioning using the BMS configuration).

Similarly, for example, radar apparatus 1 may transmit a transmission signal from a plurality of transmission antennas of radar transmitter 100-2 of second radar section 10. Radar apparatus 1 may perform positioning processing of target object #3, for example, by receiving a reflected wave signal by receiver 200-2 having a plurality of reception antennas of second radar section 10, the reflected wave signal being the transmission signal of second radar section 10 reflected by target object #3 (corresponding to target object #3 in FIG. 1) (for example, radar positioning using the MNS configuration).

Further, radar apparatus 1 may perform positioning processing of target object #2, for example, by receiving a reflected wave signal by receiver 200-1 having a plurality of reception antennas of first radar section 10, the reflected wave signal being the transmission signal of second radar section 10 reflected by target object #2 (corresponding to target object #2 in FIG. 1) (for example, radar positioning using the BMS configuration).

Note that the reception processing in first radar section 10 and second radar section 10 may be performed using, for example, a MIMO virtual antenna.

In the present embodiment, radar apparatus 1 may perform multiplexing transmission of the transmission signal transmitted first radar section 10 and the transmission signal transmitted from second radar section 10.

For example, each of first radar section 10 and second radar section 10 may include a demultiplexer that demultiplexes, from the reception signal, the reflected wave signal corresponding to the transmission signal from transmitter 100 of the corresponding radar section, and also demultiplexes the reflected wave signal corresponding to the transmission signal from transmitter 100 of the other radar section.

Further, for example, each of first radar section 10 and second radar section 10 may include a first angle measurer that measures an angle using the reflected wave signal for the transmission signal from transmitter 100 of the corresponding radar section as demultiplexed by the demultiplexer, and a second angle measurer that measures an angle using the reflected wave signal for the transmission signal from transmitter 100 of the other radar section as demultiplexed by the demultiplexer.

In FIG. 2, for example, integrator 30 may integrate positioning outputs from first radar section 10 (for example, a first and a second positioning outputs) and positioning outputs from second radar section 10 (for example, a first and a second positioning outputs) to perform positioning of the target object. Note that the positioning is information including a direction, a distance, and a Doppler frequency, and may further include demultiplexing index information (which will be described in detail later) of a Doppler multiplexed signal.

With such a configuration, radar apparatus 1 can receive the reflected wave signal at receiver 200-1 and receiver 200-2, and demultiplex the reception signal depending on whether the received signal is a reflected wave signal for the transmission signal from the corresponding radar section or a reflected wave signal for the transmission signal from the other radar section, so as to appropriately perform the positioning processing based on the positional information of each of first radar section 10 and second radar section 10. Further, since radar apparatus 1 alternately applies the FDM transmission and the same-frequency transmission at a predetermined cycle, it is possible to shorten the positioning time as compared with the case of the time-division multiplexing transmission.

For example, in FIG. 2, first radar section 10 and second radar section 10 may be disposed at locations apart from each other. In this case, radar apparatus 1 can be used as a radar of the so-called BMS configuration. For example, positioning by the radar having the BMS configuration in which the first transmission signal from first radar section 10 is received by radar receiver 200-2 of second radar section 10 and positioning by the radar having the BMS configuration in which the second transmission signal from second radar section 10 is received by radar receiver 200-1 of first radar section 10 are simultaneously possible, and thus it is possible to shorten the positioning time as compared with the case of the time-division multiplexing transmission.

Since first radar section 10 and second radar section 10 illustrated in FIG. 2 have the same configuration, they are collectively denoted and described as “radar sections 10” thereinbelow, and different operations between first radar section 10 and second radar section 10 will be described distinctively.

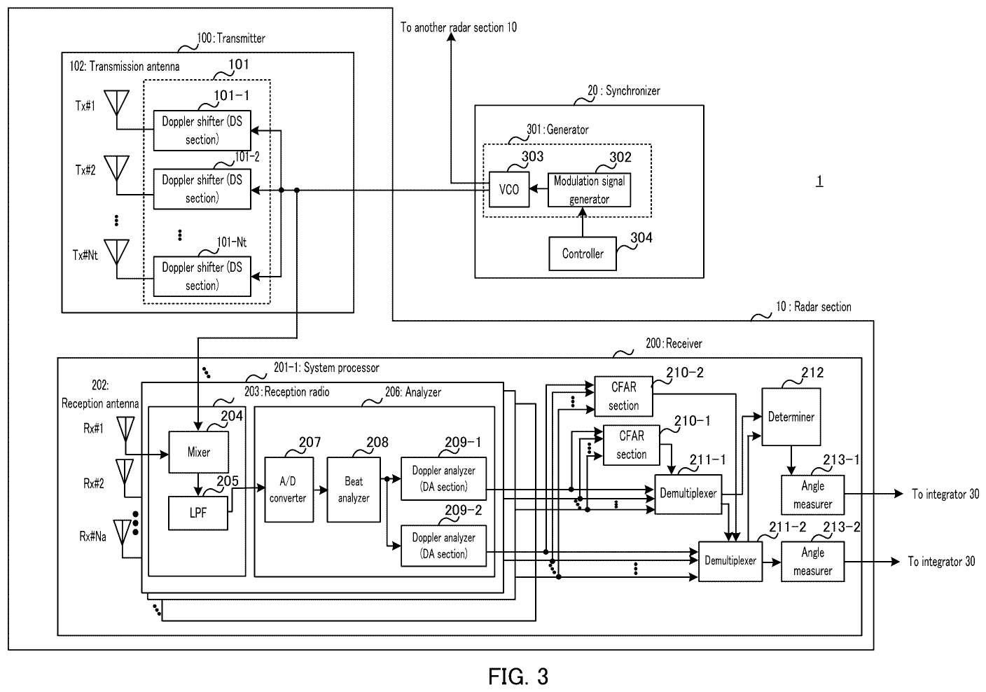

FIG. 3 illustrates an exemplary configuration of radar apparatus 1 in which a frequency-modulated chirp signal is used as a radar transmission wave.

Radar apparatus 1 in FIG. 3 illustrates details of first radar section 10-1 and synchronizer 20 in FIG. 2. For example, first radar section 10-1 corresponds to radar section 10. In FIG. 3, an exemplary configuration supported by a radar other than first radar section 10-1 and second radar section 10-2 in FIG. 2 is illustrated, and illustration of other radar section 10 is omitted.

Radar section 10 includes, for example, transmitter (corresponding to a transmission branch or radar transmission circuitry) 100 and receiver (corresponding to a reception branch or radar reception circuitry) 200.

Transmitter 100 transmits TxSig generated, for example, in synchronizer 20 at a predetermined transmission period using a transmission array antenna including a plurality of transmission antennas 102-1 to 102-Nt.

Receiver 200 receives reflected wave signals, which are TxSig reflected by a target object (target) (corresponding to target objects #1 to #3 in FIG. 1), using a reception array antenna composed of a plurality of reception antennas 202-1 to 202-Na, for example. Receiver 200 performs signal processing on the reflected wave signals received at reception antennas 202 to, for example, detect the presence or absence of the target object, or perform positioning of the target object.

For example, synchronizer 20 generates a chirp signal and supplies the chirp signal to the plurality of radar sections 10.

### [Exemplary Configuration of Synchronizer 20]

Synchronizer 20 includes, for example, generator 301 and controller 304.

Generator 301 generates TxSig based on, for example, control by controller 304. Generated TxSig may be, for example, a predetermined frequency modulated wave (e.g., a frequency chirp signal or a chirp signal). Generator 301 outputs the generated chirp signal to the plurality of radar sections 10 (for example, transmitter 100).

Generator 301 includes, for example, modulation signal generator 302 and VCO 303. Hereinafter, the components of generator 301 will be described.

Modulation signal generator 302 periodically generates, for example, saw-toothed modulation signals. The transmission period of TxSig is herein represented by Tr.

VCO 303 generates a chirp signal based on the modulation signal output from modulation signal generator 302, and outputs the chirp signal to transmitter 100 (for example, Doppler shifters 101-1 to 101-Nt) and receiver 200 (mixer 204 described later) of radar section 10. Hereinafter, the Doppler shifter is also referred to as “DS section.”

For example, when P-FDM transmission is performed, generator 301 outputs a chirp signal that is an output of VCO 303 and a chirp signal with a different center frequency resulting from frequency modification on the output of VCO 303 at the time of FDM transmission. Alternatively, at the time of FDM transmission, generator 301 may use a plurality of VCOs 303 (not illustrated) to generate chirp signals with different center frequencies.

Controller 304 controls generation of TxSig of generator 301 (for example, modulation signal generator 302 and VCO 303). For example, controller 304 may configure parameters (for example, modulation parameters) related to the chirp signal such that the chirp signal is transmitted Ne times for transmission periods Tr per one radar positioning.

Further, controller 304 may configure parameters related to the chirp signal such that that the center frequency of the chirp signal is variably set such that the FDM transmission and the same-frequency transmission in the BMS configuration are alternately applied at a predetermined period.

In the BMS configuration, the center frequency of the chirp signal by the same-frequency transmission may include a frequency identical to the center frequency of the chirp signal by the FDM transmission. Accordingly, in DFreq determination (or DFreq aliasing determination) described later, a method for expanding a Doppler detection range using a phase difference of the reception signal becomes applicable.

Further, in the BMS configuration, the center frequency of the chirp signal by the same-frequency transmission may include a difference equal to or lower than a predetermined frequency from the center frequency of the chirp signal by the FDM transmission. Accordingly, in the DFreq determination described later, the method for expanding a Doppler detection range using a difference of DFreq of the reception signal becomes applicable.

Hereinafter, a predetermined transmission period in which the FDM transmission and the same-frequency transmission are switched in the BMS configuration by controller 304 will be referred to as “N_{sw}×Tr.” N_{sw} is a predetermined integer value equal to or greater than 2.

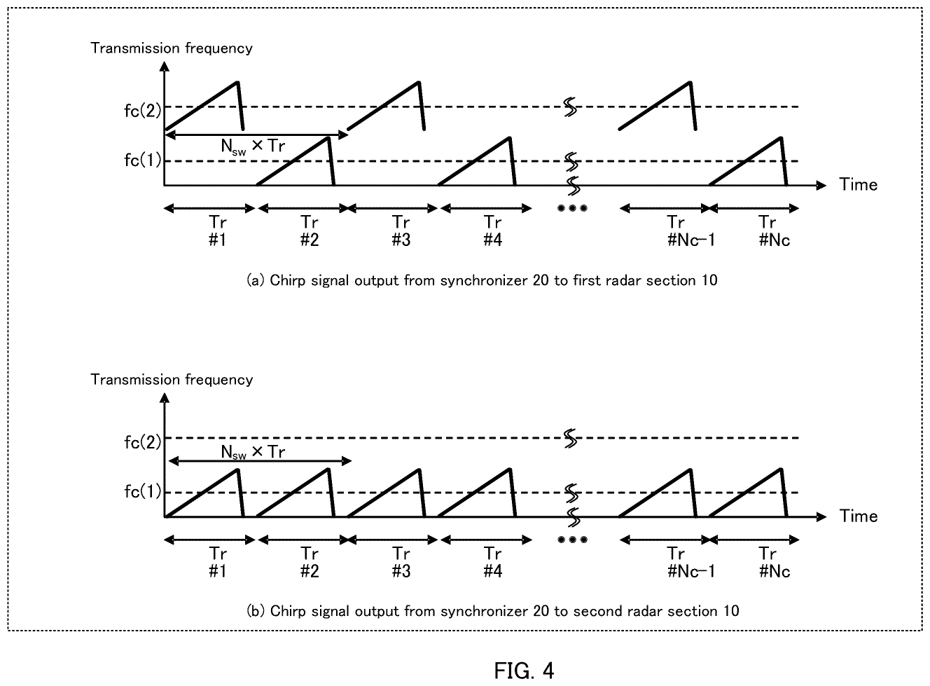

Part (a) in FIG. 4 illustrates an example of a chirp signal output by synchronizer 20 of first radar section 10, and part (b) in FIG. 4 illustrates an example of a chirp signal output by synchronizer 20 of second radar section 10. As illustrated in FIG. 4, in a plurality of transmission periods (for example, N_{sw}×Tr), for example, odd-numbered transmission periods (corresponding to the first transmission period) in which the FDM transmission is performed and even-numbered transmission periods (corresponding to the second transmission period) in which the same-frequency transmission is performed are alternately configured.

The chirp signal generated by generator 301 of synchronizer 20 is output to transmitter 100 and receiver 200 of radar section 10. In the example of FIG. 4, controller 304 configures the modulation parameters of the chirp signals such that the center frequencies of the chirp signals are varied for each transmission period Tr such that the FDM transmission and the same-frequency transmission are alternately switched at each transmission period Tr (for example, N_{sw}=2).

Here, at (a) in FIG. 4, the center frequency of the chirp signals in the odd-numbered transmission periods is set to fc(2)=fc(1)+Δfc, and the center frequency of the chirp signals in the even-numbered transmission periods is set to fc(1) for the chirp signals outputted by synchronizer 20 to first radar section 10. At (b) in FIG. 4, the center frequency of the chirp signals in the odd-numbered and even-numbered transmission periods is set to a constant value of fc(1) for the chirp signals outputted by synchronizer 20 to second radar section 10.

For example, radar apparatus 1 can detect a temporal variation of a positioning result of the target object by transmitting chirp signals in which the center frequencies are alternately switched for each transmission period Tᵣ and measuring the reflected wave signals being the chirp signals reflected at the target object a plurality of times. In the following description, each of the transmission periods among N_{c} transmission periods Tᵣ are represented by the index “m.” Here, m is an integer of from 1 through N_{c}.

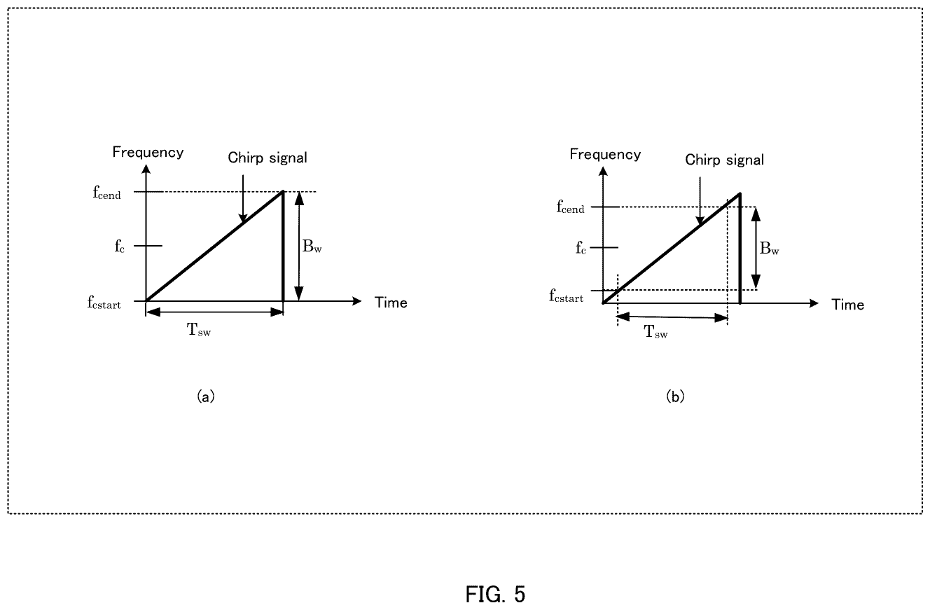

As illustrated in FIG. 5, the modulation parameters for the chirp signal may include, for example, center frequency f_{c}, frequency sweep bandwidth B_{w}, sweep start frequency f_{cstart}, sweep end frequency f_{cend}, frequency sweep duration T_{sw}, and frequency sweep change rate Dₘ. Note that Dₘ=B_{w}/T_{sw}. Note also that B_{w}=f_{cend}−f_{cstart}, and f_{c}=(f_{cstart}+f_{cend})/2.

Frequency sweep time T_{sw} corresponds to, for example, a time range (also called a range gate) in which A/D sampled data is taken by A/D converter 207 of receiver 200, which will be described later. Frequency sweep time T_{sw} may be set to an entire time section of the chirp signal illustrated at (a) in FIG. 5, or to a partial time section of the chirp signal illustrated at (b) in FIG. 5, for example.

Note that FIGS. 4 and 5 illustrate examples of up-chirp waveforms in which the modulation frequency gradually increases with time, but down-chirp may also be applied. The present disclosure can achieve the same effects regardless of whether the waveforms are up-chirp or down-chirp.

The chirp signals outputted by synchronizer 20 are inputted to, for example, each mixer 204 of receiver 200 and Nt DS sections 101.

### [Exemplary Configuration of Transmitter 100]

In FIG. 3, transmitter 100 of radar section 10 includes, for example, DS sections 101-1 to 101-Nt and transmission antennas 102-1 to 102-Nt (for example, Tx #1 to Tx #Nt). Transmission antennas 102 may be connected to respective different DS sections 101. Radar section 10 in FIG. 3 corresponds to first radar section 10, but is hereinafter referred to as qth radar section 10, including second and subsequent radar sections 10. Here, “q” represents indices for identifying a plurality of radar sections 10 included in radar apparatus 1, and may be, for example, q=1 or 2. In the following description, elements included in qth radar section 10 are described with a subindex “−q.”

To apply Doppler shift amount (hereinafter, also referred to as “DS amount”) DOPₙ(q) to the chirp signal inputted from VCO 303, each of DS sections 101 of qth radar section 10 applies phase rotation Φ_{n,q} to the chirp signal for each transmission period Tᵣ of the chirp signal, and outputs the Doppler-shifted signal to transmission antenna 102.

Further, for example, the number of transmission antennas 102 in each qth radar section 10 may be the same or may be different. Hereinafter, the number of transmission antennas in qth radar section 10 will be referred to as “Nt(q)” (or simply “Nt”). Here, Nt(q)≥1. In addition, n=1 to Nt(q).

For example, qth radar section 10 may perform outputs while giving the outpus predetermined phase rotations Φ_{n,q}(m) for applying respective different Doppler shifts to transmission antennas 102 used for the multiplexing transmission in the MNS configuration (an exemplary operation will be described later).

Further, qth radar section 10 may perform outputs while giving the outputs predetermined phase rotation Φ_{n,q}(m) to apply Doppler shifts that provide DS amount patterns different between radar sections 10 that perform multiplexing transmission, for example, in the BMS configuration (an exemplary operation will be described later). For example, the DS amount pattern (or also referred to as a Doppler shift pattern) applied to TxSig transmitted from the plurality of transmission antennas 102 of first radar section 10 may be different from the DS amount pattern in second radar section 10. The DS amount patterns may be configured according to, for example, at least one of a Doppler multiplexing interval (also referred to as “Doppler shift interval” or “Doppler interval,” which is also described as “DDM interval”) and the number of Doppler multiplexing (hereinafter, also referred to as “number of DDM”). Alternatively, qth radar section 10 may perform outputs while giving the outputs predetermined phase rotation Φ_{n,q}(m) to apply Doppler shifts that provide a pattern of DS amounts (e.g., the same DDM interval) the same between radar sections 10 that perform multiplexing transmission, for example, in the BMS configuration (an exemplary operation will be described later).

The output signals outputted from DS sections 101 are amplified to a predetermined transmission power and emitted into space from respective transmission antennas 102 (e.g., Tx #1 to Tx #Nt).

### [Exemplary Configuration of Receiver 200]

In FIG. 3, receiver 200 includes Na reception antennas 202 (for example, Rx #1 to Rx #Na), and serves as a component of an array antenna. Further, receiver 200 includes Na system processors 201, Constant False Alarm Rate (CFAR) sections 210, demultiplexers 211, determiners 212, and angle measurers 213.

Here, the number of reception antennas 202 may be the same or may be different between qth radar sections 10. Hereinafter, the number of reception antennas in qth radar section 10 will be referred to as “Na(q)” (also referred to simply as “Na”). Here, Na(q)≥1.

System processors 201 may be provided to correspond respectively to Na(q) reception antennas 202, for example. In addition, CFAR sections 210, demultiplexers 211, and angle measurers 213 may be provided, for example, in q radar sections 10, respectively.

Each of Na(q) reception antennas 202 receives a reflected wave signal being TxSig transmitted from each of the plurality of radar sections 10 and reflected by a target object (for example, a reflective object including a radar measurement target), and outputs the reflected wave signal to corresponding system processor 201 as a reception signal.

Each of system processors 201 includes reception radio 203 and analyzer 206.

Reception radio 203 includes mixer 204 and low pass filter (LPF) 205. In reception radio 203, mixer 204 mixes the received reflected wave signal (reception signal) with the chirp signal that is the transmission signal. Further, a beat signal having a frequency corresponding to a delay time of the reflected wave signal is extracted by passing an output of mixer 204 through LPF 205. For example, a difference frequency between a frequency of the transmission signal (transmission frequency-modulated wave) and a frequency of the reception signal (reception frequency-modulated wave) is obtained as the beat frequency (or beat signal). Note that the beat frequency is within the passband of LPF 205.

Here, a signal falling outside the passband of LPF 205 is attenuated and is not received by receiver 200. For example, in the BMS configuration, a reflected wave signal resulting from FDM transmission from first radar section 10 has frequency difference Δfc (fc(2)−fc(1) in FIG. 4) causing the reflected wave signal to fall outside the passband of LPF 205 of second radar section 10, and thus is not received by receiver 200 of second radar section 10.

In FIG. 3, analyzer 206 of each system processor 201-z (where z=any one of 1 to Na(q)) includes A/D converter 207, beat analyzer 208, and Doppler analyzer (also referred to as “DA section”) 209.

The signal (for example, beat signal) outputted from LPF 205 is converted into discretely sampled data by A/D converter 207 in analyzer 206.

Beat analyzer 208 performs, for each transmission period Tᵣ, FFT processing on N_{data} pieces of discretely sampled data obtained in a predetermined time range (range gate). Here, the range gate may set frequency sweep time T_{sw}. Analyzer 206 thus outputs a frequency spectrum in which a peak appears at a beat frequency dependent on the delay time of the reflected wave signal (radar reflected wave). In the FFT processing, for example, beat analyzer 208 may perform multiplication by a window function coefficient such as the Han window or the Hamming window. The use of the window function coefficient can suppress sidelobes around the beat frequency peak.

Here, a beat frequency response (hereinafter, also referred to as “BF response”) obtained by the mth chirp pulse transmission of the chirp signal, which is outputted from beat analyzer 208 in zth analyzer 206, is denoted as “RFT_{z}(f_{b}, m).” Here, f_{b} denotes the beat frequency index and corresponds to an FFT index (bin number). For example, fb=0 to N_{data}/2−1, z=an integer of from 1 to Na, and m=an integer of from 1 to N_{C}. A beat frequency having smaller beat frequency index fb indicates a shorter delay time of the reflected wave signal (for example, a shorter distance to the target object).

In addition, beat frequency index fb may be converted to distance information R(f_{b}) using Expression 1 for the MNS configuration and Expression 2 for the BMS configuration. Thus, in the following, beat frequency index f_{b} is also referred to as “distance index f_{b}.” The distance index is also described as “R-Index.”

$$R ( {f}_{b} ) = \frac{{c}_{0} {f}_{b}}{2 {B}_{w}} \qquad ( Expression 1 )$$

$$R ( {f}_{b} ) = \frac{{c}_{0} {f}_{b}}{{B}_{w}} \qquad ( Expression 2 )$$

Here, B_{w} denotes a frequency sweeping bandwidth within the range gate for a chirp signal, and C₀ denotes the speed of light.

DA sections 209 of zth analyzer 206 perform Doppler analysis for each R-Index by using BF response RFT_{z}(f_{b}, m) obtained by N_{C} chirp pulse transmissions of the chirp signal (e.g., m=1 to N_{C}).

In the following, as illustrated in FIG. 4, an exemplary operation of each DA section 209 performed when the FDM transmission and the same-frequency transmission are alternately switched for each transmission period Tᵣ in the BMS configuration will be described.

The zth DA section 209 performs Doppler analysis for each R-Index by using, from among BF responses RFT_{z}(f_{b}, m) obtained by N_{C} chirp pulse transmissions, a BF response (e.g., BF response in the case where m is an odd number) obtained from a reception signal resulting from the FDM transmission in the BMS configuration.

For example, in the BMS configuration, mixer 204 of second radar section 10 mixes the reception signal from first radar section 10 performing the FDM transmission using outputs of VCO 303 in the MNS configuration. Thus, the reception signal from first radar section 10 having frequency difference Δfc falls outside the passband of LPF 205 of the second radar section.

Therefore, each radar section 10 receives, as a reception signal by FDM transmission in the BMS configuration, a reflected wave signal in the MNS configuration, but does not receive the reflected wave signal of TxSig from another radar section 10 in the BMS configuration and in the FDM transmission.

Hereinafter, DA section 209 (in FIG. 3, Doppler analyzer 209-1) that performs Doppler analysis using such a reflected wave signal is also referred to as a “first Doppler analyzer (DA section) 209” or a “mono-reception Doppler analyzer (DA section).”

In addition, DA section 209 performs Doppler analysis for each R-Index by using a BF response (for example, a BF response in which m is an even number) obtained from a reception signal of the same-frequency transmission in the BMS configuration.

For example, mixer 204 mixes the reception signal of the same-frequency transmission by using an output of VCO 303 for the same-frequency transmission in the MNS configuration and the BMS configuration. Therefore, each radar section 10 receives a signal in which the reflected wave signal in the MNS configuration and the reflected wave signal in the BMS configuration are mixed.

Hereinafter, DA section 209 (in FIG. 3, Doppler analyzer 209-2) that performs Doppler analysis using such a reflected wave signal is also referred to as a “second Doppler analyzer (DA section) 209” or a “mono-reception Doppler analyzer (DA section).”

For example, when N_{VFT}=N_{c}/N_{sw} is a power of 2, DA section 209 of qth radar section 10 can apply FFT processing in the Doppler analysis. Here, the FFT size in the mono-reception DA section and the mono- & multi-reception DA section is N_{VFT}, and the maximum DFreq at which no aliasing occurs and which is derived from the sampling theorem is +1/(2N_{sw}Tᵣ). Further, the DFreq interval of DFreq index (also referred to as “DF-Index”) fₛ is 1/(N_{c}×Tᵣ), and the range of fₛ is fₛ=−N_{VFT}/2, . . . , 0, . . . , and N_{VFT}/2−1.

For example, output VFT_{z,q}^{Mono}(f_{b}, fₛ) of the mono-reception DA section and output VFT_{z,q}^{Mix}(f_{b}, fₛ) of the mono- & multi-reception DA section from among DA sections 209 in zth analyzer 206 of qth radar section 10 are given by following Expressions 3 and 4. Here, j is an imaginary unit, z is an integer of from 1 to Na(q), and q is 1 or 2. In addition, the BF response outputted by beat analyzer 208 in qth radar section 10 is expressed as “RFT_{z,q}(f_{b}, m”). The same applies hereinafter.

$${VFT}_{z , q}^{Mono} ( {f}_{b} , {f}_{s} ) = {\sum }_{s = 0}^{{N}_{VFT} - 1} {RFT}_{z , q} ( {f}_{b} , {N}_{sw} \times s + 1 ) exp [ - \frac{j 2 π {sf}_{s}}{{N}_{VFT}} ] \qquad ( Expression 3 )$$

$${VFT}_{z , q}^{Mix} ( {f}_{b} , {f}_{s} ) = {\sum }_{s = 0}^{{N}_{VFT} - 1} {RFT}_{z , q} ( {f}_{b} , {N}_{sw} \times s + 2 ) exp [ - \frac{j 2 π {sf}_{s}}{{N}_{VFT}} ] \qquad ( Expression 4 )$$

The processing in each component of analyzer 206 has been described above.

In FIG. 3, CFAR sections 210 of qth radar section 10 may include, for example, first CFAR section 210-q (also expressed as CFAR section 210-1-q) corresponding to the MNS configuration, and second CFAR section 210-q (also expressed as CFAR section 210-2-q) corresponding to the mono- & multi-static configuration.

First CFAR section 210-q performs CFAR processing (for example, adaptive threshold determination) using the outputs from first DA sections (mono-reception DA sections) 209 of first to Na(q)th analyzers 206 to extract R-Index (hereinafter, also referred to as f_{bp}^{Mono}) and DF-Index (hereinafter, also referred to as fₛₚ^{Mono}) that provide local peak signals.

Likewise, second CFAR section 210-q performs CFAR processing using the outputs from second DA sections (mono- & multi-reception DA sections) 209 of first to Na(q)th analyzers 206 to extract R-Index (hereinafter, also referred to as f_{bp}^{Mix}) and DF-Index (hereinafter, also referred to as fₛₚ^{Mix}) that provide local peak signals. Note that, fₛₚ^{Mono} and fₛₚ^{Mix} may include DF-Index for the number of Doppler multiplexing.

For example, first CFAR section 210-q selectively extracts local peaks of the reflected wave signals (referred to as reception signals or reflected wave signals in the MNS configuration) of TxSig from qth radar section 10 as the MNS configuration using the outputs of first DA sections 209 of first to Na(q)th analyzers 206. For example, first CFAR section 210-q may perform the CFAR processing of performing the adaptive threshold determination after power addition at intervals matching the DDM intervals configured for TxSig transmitted from qth radar section 10, extract f_{bp}^{Mono} and fₛₚ^{Mono}, and output extracted f_{bp}^{Mono} and fₛₚ^{Mono} to first demultiplexer 211 (an exemplary operation will be described later).

The transmitter of the MNS configuration in qth radar section 10 is transmitter 100 of qth radar section 10. Similarly, the transmitter of the MNS configuration in geth radar section 10 is transmitter 100 of first geth radar section 10. Note that qth radar section 10 and qeth radar section 10 are different radar sections, and qe=2, for example, when q=1.

Further, for example, second CFAR section 210-q selectively extracts local peaks of the reflected wave signals (referred to as reception signals or reflected wave signals in the BMS configuration) of TxSig from qeth radar section 10 as the BMS configuration using the outputs of second DA sections 209 of first to Na(q)th analyzers 206.

For example, second CFAR section 210-q may perform the CFAR processing of performing the adaptive threshold determination after power addition at intervals matching the DDM intervals configured for TxSig transmitted from qeth radar section 10 different from qth radar section 10, extract f_{bp}^{Mix} and fₛₚ^{Mix} and output extracted f_{bp}^{Mix} and fₛₚ^{Mix} to second demultiplexer 211 (an exemplary operation will be described later).

When the DDM intervals configured for TxSig from qeth radar section 10 are identical to the DDM intervals configured for TxSig from qth radar section 10, the reflected wave signal in the MNS configuration is also detected. In this case, for example, second CFAR section 210-q also extracts f_{bp}^{Mon} and fₛₚ^{Mono} extracted in first CFAR section 210-q (an exemplary operation will be described later).

Further, the transmitter having the BMS configuration in first radar section 10 is transmitter 100 of second radar section 10. Likewise, transmitter 100 having the BMS configuration in second radar section 10 is transmitter 100 of first radar section 10.

Demultiplexers 211 of qth radar section 10 may include first demultiplexer 211-q (also expressed as demultiplexer 211-1) that performs Doppler demultiplexing processing (hereinafter, also referred to as “DDM demultiplexing”) using the outputs of first DA section 209 and first CFAR section 210-q, and second demultiplexer 211-q (also referred to as demultiplexer 211-2) that performs DDM demultiplexing processing using the outputs of second DA section 209, second CFAR section 210-q, and first demultiplexer 211.

For example, first demultiplexer 211-q of qth radar section 10 performs the DDM demultiplexing on the reflected wave signals (e.g., corresponding to first reflected wave signals) in the MNS configuration using the outputs of first CFAR section 210-q. Further, second demultiplexer 211-q of qth radar section 10 performs the DDM demultiplexing on the reflected wave signals (e.g., corresponding to second reflected wave signals) in the MNS configuration and the reflected wave signals (e.g., third reflected wave signals) in the BMS configuration using the outputs of first demultiplexer 211-q and the outputs of second CFAR section 210-q.

Further, first demultiplexer 211-q outputs, for example, information on the demultiplexed signals to determiner 212. The output of first demultiplexer 211-q may include, for example, the outputs from first DA sections 209.

Further, for example, second demultiplexer 211-q outputs, to determiner 212, information related to the signal from which the reflected wave signal in the MNS configuration is demultiplexed. Further, for example, second demultiplexer 211-q outputs, to second angle measurer 213-2, information about the signal from which the reflected wave signal in the BMS configuration is demultiplexed. The output of second demultiplexer 211-q may include, for example, the outputs from second DA sections 209.

The information about the demultiplexed signal may include, for example, R-Index and DF-Index corresponding to the separated signal (which may also be referred to as demultiplexing index information below).

In the following, the exemplary operation of qth demultiplexer 211 will be described together with the exemplary operation of Doppler shifters 101 and qth CFAR section 210. For example, q=1 or 2 may hold true.

The operation of Nuth demultiplexer 211-q is related to the operation of DS sections 101 of transmitter 100-q. Similarly, the operation of Nuth CFAR section 210-q is related to the operation of DS sections 101 of transmitter 100-q. For example, Nu=1 or 2 may hold true.

Hereinafter, an exemplary operation of DS sections 101 will be described, and an exemplary operation of Nuth CFAR section 210-q and an exemplary operation of Nuth demultiplexer 211-q will then be described.

### [Configuration Method for DS Amount]

To begin with, an example of a configuration method the DS amount applied in DS sections 101 will be described.

First to Nt(q)th DS sections 101 of qth radar section 10 perform Doppler multiplexing transmission (hereinafter, also referred to as “DDM transmission”) by applying respective different DS amounts DOPₙ(q) of predetermined DDM intervals Δfd(q) to the chirp signals inputted from synchronizer 20. At this time, DDM intervals Δfd(q) may satisfy the following configuration condition (1) or (2).

### Configuration Condition (1):

The DDM intervals may be set to the same interval between the plurality of radar sections 10. For example, the intervals for respective DS amounts applied to TxSig transmitted from the plurality of transmission antennas 102 of first radar section 10 may be the same as the intervals for respective DS amounts applied to TxSig transmitted from the plurality of transmission antennas 102 of second radar section 10 (for example, Δfd(1)=Δfd(2)).

### Configuration Condition (2):

The DDM intervals between the plurality of radar sections 10 may be set to different intervals. For example, the intervals for respective DS amounts applied to TxSig transmitted from the plurality of transmission antennas 102 of first radar section 10 and the intervals for respective DS amounts applied to TxSig transmitted from the plurality of transmission antennas 102 of second radar section 10 may be different from each other (for example, Δfd(1)≠Δfd(2)).

Note that, for example, the ratio between Δfd(1) and Δfd(2) may be set in configuration condition (2) so as not to match an integer. For example, of Δfd(1) and Δfd(2), the ratio of the DDM interval having the larger value to the DDM interval having the smaller value may be different from the integer. For example, Δfd(1)/Δfd(2) or Δfd(2)/Δfd(1) may be set so as not to match the integer (so as to be different from the integer).

Hereinafter, a configuration example of DDM interval Δfd(q) will be described.

In the following description, the number of DDM for qth radar section 10 will be referred to as “N_{DM}(q),” and a description is given of a case of N_{DM}(q)=Nt(q), but the present disclosure is not limited thereto. For example, radar section 10 may bundle some of the plurality of transmission antennas 102 to form a transmission beam for performing DDM transmission. Here, N_{DM}(q)<Nt(q) holds true. Further, for example, index n of DS amount DOPₙ(q) represents an index of the DDM signal, and n is an integer of from 1 to N_{DM}(q). Also, N_{DM}(q)>1 and q=1 or 2. Note that, when Nt(q)=1, Doppler shift multiplexing does not have to be used, and qth radar section 10 does not have to include DS sections 101.

In the present embodiment, controller 304 configures the modulation parameters of the chirp signals such that FDM transmission and the same-frequency transmission in the BMS configuration are switched at every transmission period. For this reason, for example, DS sections 101 apply a phase rotation providing a predetermined DS amount to a chirp signal at each transmission period (for example, N_{sw}×Tr) for the FDM transmission of the chirp signal, and similarly applies a phase rotation providing a predetermined DS amount to a chirp signal at each transmission period (for example, N_{sw}×Tr) for the same-frequency transmission of the chirp signal.

For example, as illustrated at (a) and (b) in FIG. 4, when the FDM transmission and the same-frequency transmission in the BMS configuration are alternately switched for each transmission period Tr, DS sections 101 applies phase rotations providing predetermined DS amounts with N_{sw}=2.

Here, in DA sections 209 (the mono-reception DA section or the mono- & multi-reception DA section), the range of DFreq f_{d} in which no aliasing is generated and which is derived from the sampling theorem is −1/(2N_{sw}Tᵣ)≤f_{d}<1/(2N_{sw}Tᵣ). For example, when the Doppler frequency exceeds the range of DFreq fa in which no aliasing occurs, DA sections 209 observe an aliasing frequency in the range of −1/(2N_{sw}Tᵣ)≤f_{d}<1/(2N_{sw}Tᵣ). Therefore, even when the Doppler shift applied by DS sections 101 is set within a range exceeding −1/(2N_{sw}Tᵣ)≤f_{d}<1/(2N_{sw}Tᵣ), the Doppler shift is equivalent to that set within the range of −1/(2N_{sw}Tᵣ)≤f_{d}<1/(2N_{sw}Tᵣ).

Therefore, for example, when DS sections 101 apply the Doppler shift within the range of −1/(2N_{sw}Tᵣ)≤f_{d}<1/(2N_{sw}Tᵣ), the maximum DDM interval (for example, expressed as “Δfdmax”) for Nt(q) transmission antennas 102 (for example, the number equal to the number of DDM) is Δfdmax=1/(TᵣN_{sw}Nt(q))=1/(TᵣN_{sw}N_{DM}(q)). For example, DS sections 101 may set Δfd(1) and Δfd(2) within the range up to Δfdmax. Accordingly, DS sections 101 can set the Doppler shift within the range of 0 to 2π that is the phase rotation providing the Doppler shift.

For example, the DDM intervals of each of first radar section 10 and second radar section 10 may be set as given by following Expression 5:

$$Δ fd ( q ) = 1 / ( {N}_{s w} {T}_{r} \times ( {N}_{D M} ( q ) + {δ}_{q} ) ) . \qquad ( Expression 5 )$$

For example, δ_{q} is a parameter that defines the DDM interval. Equations δ₁=δ₂≥0 and N_{DM}(1)=N_{DM}(2) may be set. With this configuration, the DDM interval is the same between the plurality of radar sections 10 (for example, between first radar section 10 and second radar section 10), and satisfies configuration condition (1) (Δfd(1)=Δfd(2)).

Alternatively, δ₁ and δ₂ may be set such that δ₁, δ₂≥0 holds true, N_{DM}(1)+δ₁≠N_{DM}(2)+δ₂ is satisfied, and the ratio between N_{DM}(1)+δ₁ and N_{DM}(2)+δ₂ does not match an integer. With this configuration, the DDM interval differs between the plurality of radar sections 10 (for example, between first radar section 10 and second radar section 10), and satisfies configuration condition (2).

Note that each of δ₁ and δ₂ may be a positive integer or a positive real number. For example, by setting δ₁ and δ₂ to be positive integers, the processes in first CFAR section 210 and second CFAR section 210, which will be described later, can be simplified. Descriptions are given below of a case where δ₁ and δ₂ are each set to zero or a positive integer. However, the present disclosure is not limited thereto, and positive real numbers may be set.

In addition, when supposed situations are mostly those in which radar apparatus 1 and the target object are both stationary, a configuration may be adopted in which parameters (for example, DDM intervals Δfd(q) or δ_{q}) which, for example, cause the DS amounts to match each other between first radar section 10 and second radar section 10 are excluded in advance. For example, for all of n₁ and n₂, the parameters may be set so as to satisfy following Expression 6:

$${DOP}_{n 1} ( 1 ) \neq {DOP}_{n 2} ( 2 ) , {n}_{1} ∈ \{ 1 , 2 , … Nt ( 1 ) \} , {n}_{2} ∈ \{ 1 , 2 , … Nt ( 2 ) \} . \qquad ( Expression 6 )$$

By this configuration, for example, DS amount DOPₙ1(1) applied to TxSig of first radar section 10 and DS amount DOPₙ2(2) applied to TxSig of second radar section 10 are set to values different from each other.

For example, when radar apparatus 1 and the target object are both stationary, a Doppler component is zero. Therefore, for example, even when the reflected wave signal of TxSig from first radar section 10 and the reflected wave signal of TxSig from second radar section 10 are included in the same R-Index, DS amount DOPₙ(q) for each MIMO multiplexed transmission signal is set differently, making it possible for radar apparatus 1 to demultiplex and receive both the reflected wave signals by utilizing the difference in detected Doppler components.

Hereinafter, a configuration example of DS amounts will be described.

### [Configuration Example 1]

Configuration example 1 is a configuration example of a DS amount satisfying configuration condition 1.

For example, in Expression 5 in which q=1, 2 is substituted, configurations that satisfies configuration condition 1 are following condition a and condition b.

Condition a) Case of N_{DM}(1)=N_{DM}(2):

By setting δ₁=δ₂≥0 in Expression 5 in which q=1, 2 is substituted, Δfd(1)=Δfd(2) is obtained. Here, δ₁ and δ₂ may be an integer.

Condition b) Case of N_{DM}(1)≠N_{DM}(2):

By setting q=1, 2 in Expression 5 in which N_{DM}(1)+δ₁=N_{DM}(2)+δ₂, Δfd(1)=Δfd(2) is obtained.

Here, δ₁ and δ₂ may be an integer.

When δ₁=δ₂=0 is set in Expression 5 in which q=1, 2 is substituted, the DDM intervals can be maximized within the range, −1/(2N_{sw}Tᵣ)≤f_{d}<1/(2N_{sw}Tᵣ), of DFreq fa observed in DA sections 209. Therefore, for example, even in a case where the Doppler spectrum has a spread, such as a case where the moving speed of the target is not constant and has a component such as acceleration, the interference effect between the DDM signals can be reduced. Meanwhile, in this case, enlarging observable DFreq by using the non-uniformity of DDM intervals as disclosed in PTL 3 becomes a difficult condition and DFreq falls within −1/(2N_{sw}×Tᵣ×N_{DM}(1))≤f_{d}<1/(2N_{sw}×Tᵣ×N_{DM}(1)). The same applies to the following configuration conditions.

In addition, when δ₁=δ₂>0 is set in Expression 5 in which q=1 and q=2 are substituted, observable DFreq can be enlarged using the non-uniformity of DDM intervals as disclosed in PTL 3, and DFreq of the target object can be detected in the range −1/(2N_{sw} Tᵣ)≤f_{d}<1/(2N_{sw}Tᵣ) of DFreq fa observed in DA sections 209. Further, by applying determiner 212 described later, DFreq of the target object can be detected in the range −1/(2Tr)≤f_{d}<1/(2Tr) of DFreq f_{d} (detailed description will be given later). The same applies to the following configuration conditions.

Hereinafter, an example of DS amounts in configuration example 1 will be described.

<Configuration Examples 1-a-1 and 2>

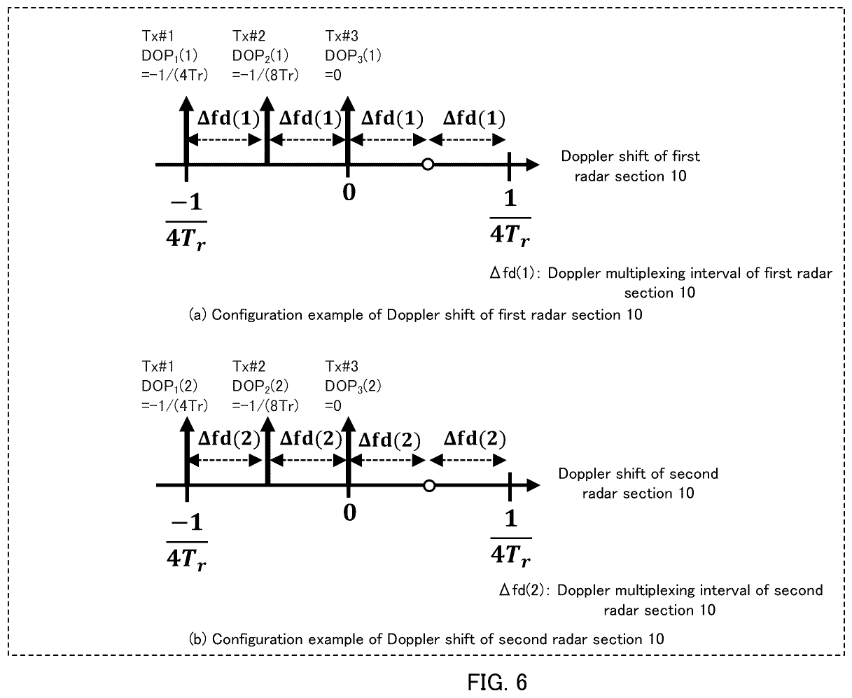

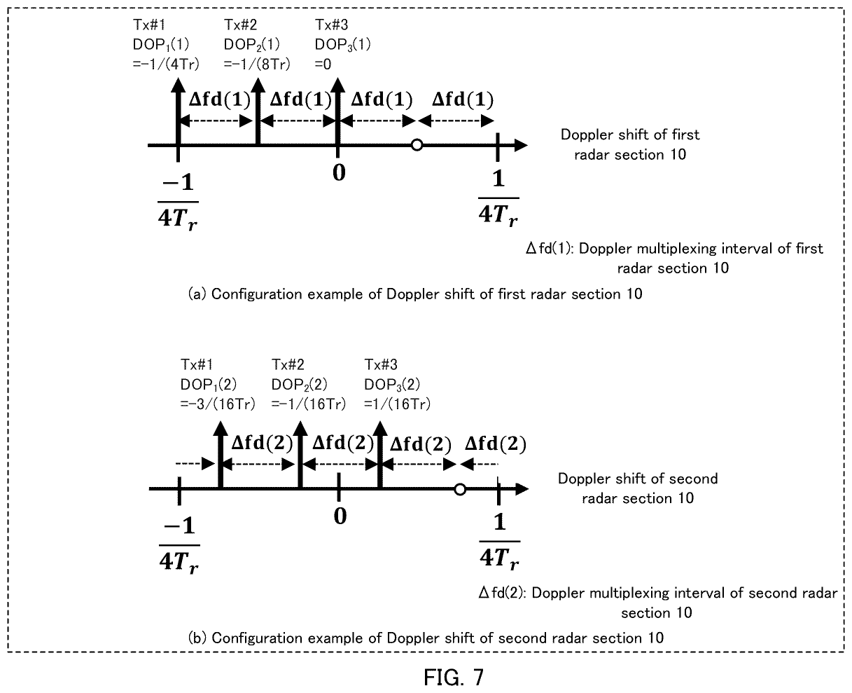

FIGS. 6 and 7 illustrate, by way of example, a configuration example of the Doppler shifts of first radar section 10 ((a) in each figure) and a configuration example of the Doppler shifts of second radar section 10 ((b) in each figure) in the case where N_{sw}=2, N_{DM}(1)=N_{DM}(2)=3, and δ₁=δ₂=1 and when Δfd(1)=Δfd(2)=1/(8Tr) holds true.

For example, FIG. 6 illustrates DS amounts DOPₙ(q) allocated to transmission antennas 102 (e.g., Tx #1 to Tx #3) of first radar section 10 and second radar section 10. Here, n=1 to 3 and q=1, 2. The DDM intervals, which are Doppler shift intervals assigned to the transmission antennas, are set to an integer multiple of Δfd(1) or Δfd(1).

In the example illustrated in FIG. 6, all the DS amounts are the same between first radar section 10 and second radar section 10.

Further, in FIG. 7, the DS amounts applied to respective transmission antennas 102 of first radar section 10 and second radar section 10 are configured so that the DS amounts do not match each other between first radar section 10 and second radar section 10 (for example, so as to satisfy Expression 6). For example, at (a) in FIG. 7, DS amount DOPₙ(1) allocated to each transmission antenna 102 of first radar section 10 is configured in the same manner as at (a) in FIG. 6, and at (b) in FIG. 7, DS amount DOPₙ(2) allocated to each transmission antenna 102 of second radar section 10 is set to a value offset by 1/(16Tr) from each of the DS amounts of first radar section 10.

<Configuration Examples 1-a-3 and 4>

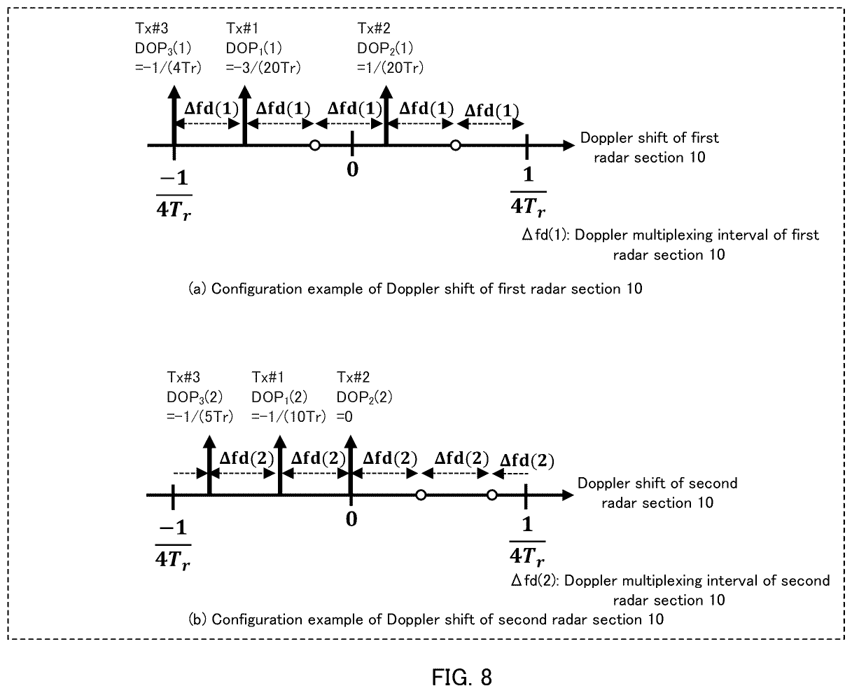

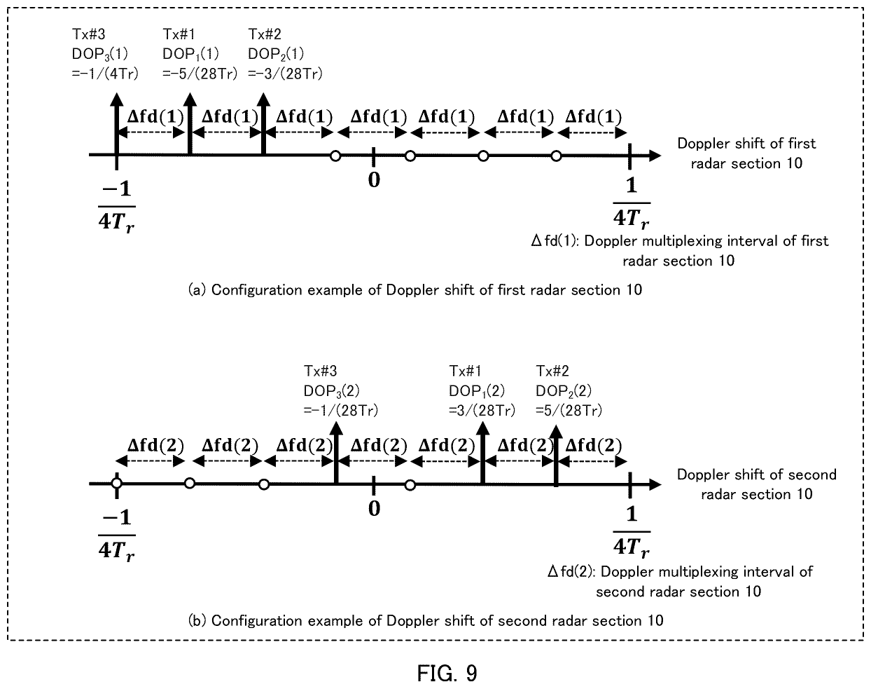

FIGS. 8 and 9 illustrate, by way of example, configuration examples of the Doppler shifts of first radar section 10 ((a) in each figure) and a configuration example of the Doppler shifts of second radar section 10 ((b) in each figure) in the case where N_{sw}=2, N_{DM}(1)=N_{DM}(2)=3, δ₁=δ₂=2, and Δfd(1)=Δfd(2)=1/(10Tr) and in the case where N_{sw}=2, N_{DM}(1)=N_{DM}(2)=3, δ₁=δ₂=4, and Δfd(1)=Δfd(2)=1/(14Tr).

In FIGS. 8 and 9, DS amounts that do not match each other even with cyclic shifting within a DFreq range of ±1/(2N_{sw}×Tr) are used for the configuration of the Doppler shifts of first radar section 10 and second radar section 10. By this configuration, even when a reception signal in the MNS configuration and a reception signal in the BMS configuration are mixed in subsequent demultiplexer 211, the reception signal in the MNS configuration and the reception signal in the BMS configuration can be distinguished from each other, and the demultiplexing performance of radar apparatus 1 can be improved (described later).

Further, in FIGS. 8 and 9, DS amounts DOPₙ(q) applied to respective transmission antennas 102 of first radar section 10 and second radar section 10 are set so that the DS amounts do not match each other between first radar section 10 and second radar section 10. Here, n=1 to 3 and q=1, 2. The DDM intervals assigned to the transmission antennas are set to integer multiples of Δfd(1) or Δfd(1).

In addition, in FIG. 9 (configuration example 1-a-4), the Doppler shift configuration (for example, Doppler peak) of first radar section 10 and the Doppler shift configuration (for example, Doppler peak) of second radar section 10 are set separately from each other so as to be lumps (or not to be mixed).

<Configuration Example 1-b-1>

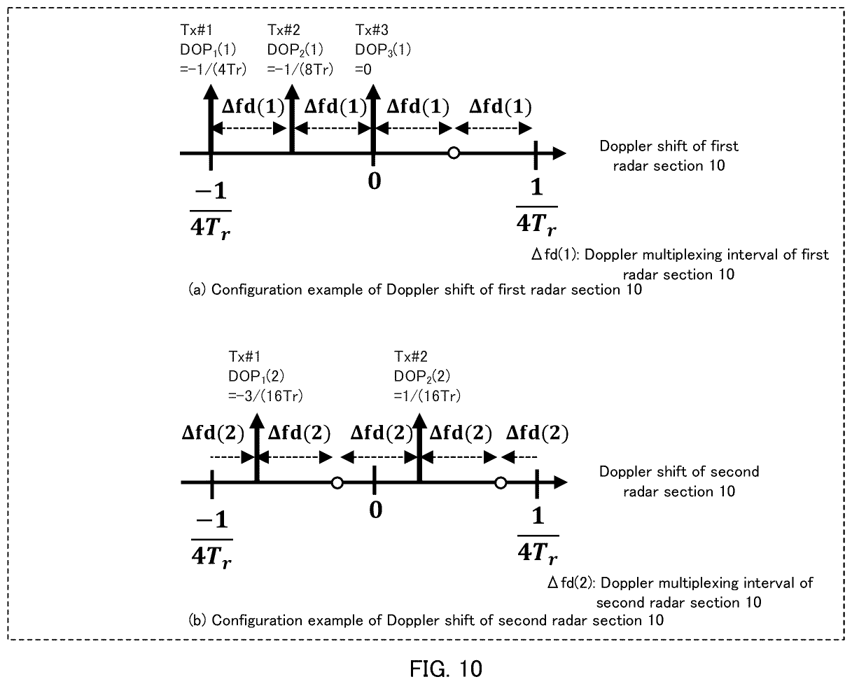

For example, it is possible to set Δfd(1)=Δfd(2)=1/(8Tr) by setting N_{sw}=2, N_{DM}(1)=3, N_{DM}(2)=2, δ₁=1, and δ₂=2. Part (a) in FIG. 10 illustrates a Doppler shift configuration example of first radar section 10, and (b) in FIG. 10 illustrates a Doppler shift configuration example of second radar section 10.

In FIG. 10, DDM intervals assigned to the respective transmission antennas are set to integer multiples of Δfd(1) or Δfd(1). For example, in FIG. 10, in the Doppler shift configurations assigned to the respective transmission antennas of first radar section 10 and second radar section 10, patterns of DS amounts that do not match each other even with cyclic shifting within the DFreq range of ±1/(2N_{sw}×Tr) because of different numbers of DDM (N_{DM}(1)≠N_{DM}(2)) are used. By the Doppler shift configuration in FIG. 10, it is possible to improve the demultiplexing performance when the reception signal in the MNS configuration and the reception signal in the BMS configuration are mixed in subsequent demultiplexer 211 (detailed description will be given later).

Further, in FIG. 10, the DS amounts applied to respective transmission antennas 102 of first radar section 10 and second radar section 10 are set so that the DS amounts do not match each other between first radar section 10 and second radar section 10. For example, at (a) in FIG. 10 and (b) in FIG. 10, values satisfying Expression 6 are assigned.

### [Configuration Example 2]

Configuration example 2 is a configuration example of DS amounts satisfying configuration condition 2.

For example, in Expression 5 in which q=1, 2 is substituted, a configuration that satisfies above-described configuration condition 2 of DDM interval Δfd(q) is following condition a and condition b.

Condition a) Case of N_{DM}(1)=N_{DM}(2):

By setting δ₁≠δ₂≥0, Δfd(1)≠Δfd(2) is obtained. Here, δ₁ and δ₂ may be an integer. For example, δ₁≠δ₂ may be set to a positive integer.

Condition b) Case of N_{DM}(1)≠N_{DM}(2):

By setting δ₁=δ₂≥0, Δfd(1)≠Δfd(2) is obtained.

Further, a configuration satisfying the following conditions may also be used.

By setting N_{DM}(1)+δ₁≠N_{DM}(2)+δ₂, Δfd(1)≠Δfd(2) is obtained.

Here, δ₁, δ₂ may be an integer. For example, δ₁≠δ₂ may be a positive integer. At this time, δ₁ and δ₂ may be set such that the ratio between Δfd(1) and Δfd(2) does not match an integer. Further, δ₁ and δ₂ may be set such that the DS amounts do not match each other between first radar section 10 and second radar section 10 (for example, so as to satisfy Expression 6).

Hereinafter, the DS amounts in configuration example 2 will be described.

<Configuration Example 2-a-1>

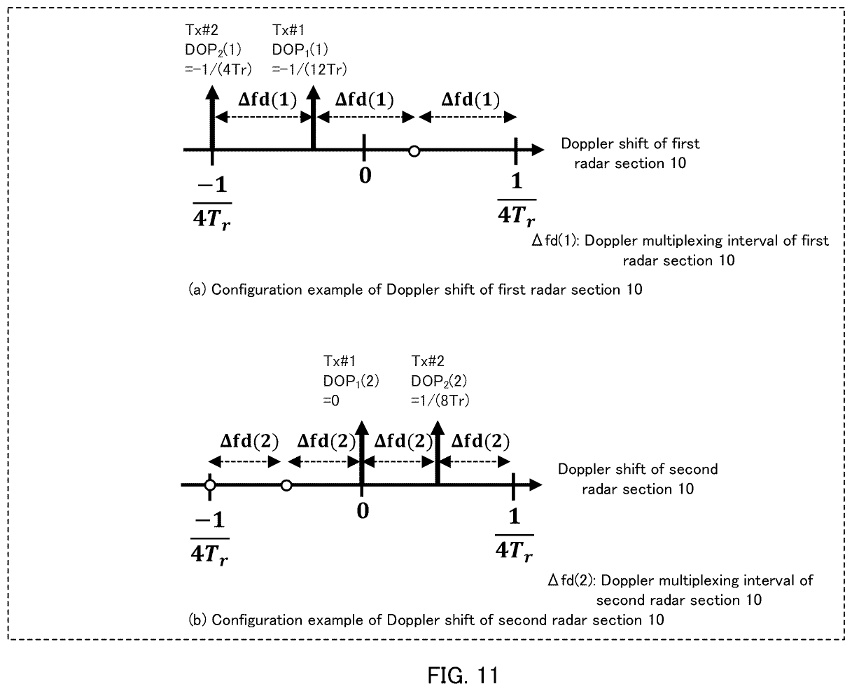

By way of example, FIG. 11 illustrates a configuration example of Doppler shifts of first radar section 10 ((a) in FIG. 11) and a configuration example of Doppler shifts of second radar section 10 ((b) of FIG. 11) in a case of Δfd(1)=1/(6Tr), Δfd(2)=1/(8Tr), N_{sw}=2, N_{DM}(1)=N_{DM}(2)=2, δ₁=1, and δ₂=2.

In FIG. 11, the ratio between Δfd(1) and Δfd(2) does not match an integer, and configuration condition 2 of DDM intervals Δfd(q) is satisfied.

<Configuration Example 2-b-1>

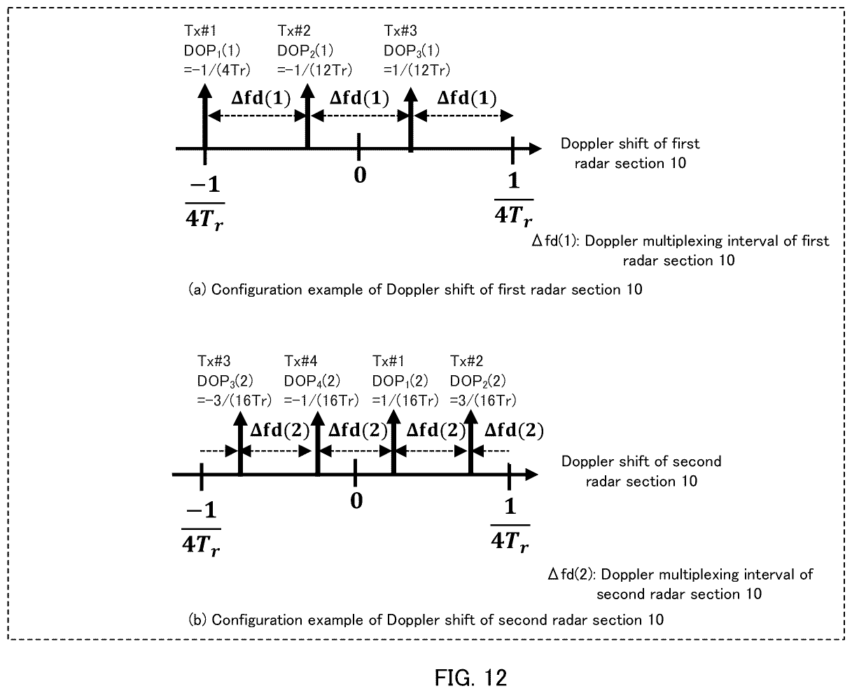

By way of example, FIG. 12 illustrates a configuration example of Doppler shifts of first radar section 10 ((a) in FIG. 12) and a configuration example of Doppler shifts of second radar section 10 ((b) of FIG. 12) in a case of N_{sw}=2, N_{DM}(1)=3, N_{DM}(2)=4, δ₁=δ₂=0.

In the example of FIG. 12, Δfd(1)=1/(6Tr) and Δfd(2)=1/(8Tr), and the ratio between Δfd(1) and Δfd(2) does not match an integer. Thus, configuration condition 2 of DDM intervals Δfd(q) is satisfied.

<Configuration Example 2-b-2>

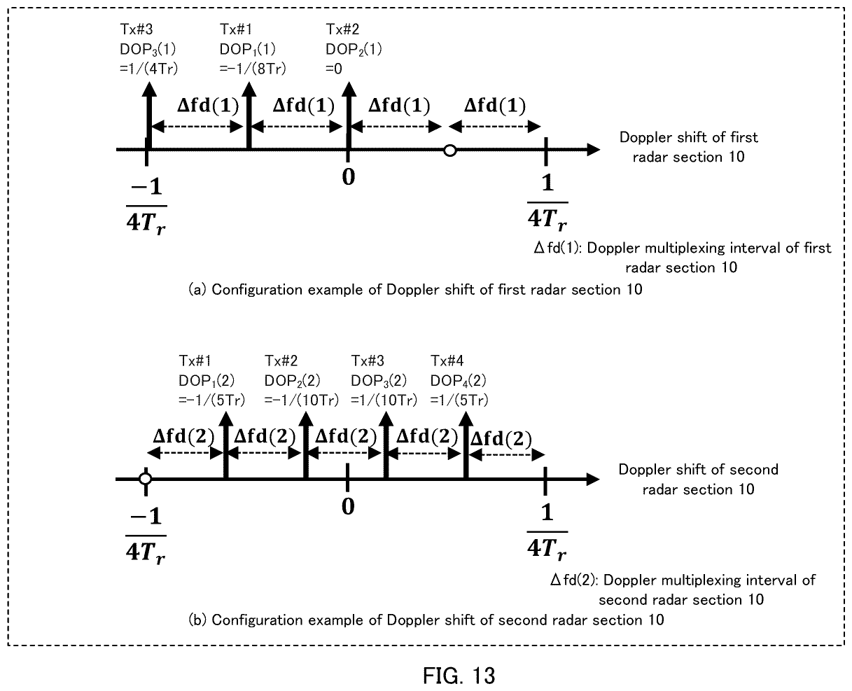

By way of example, FIG. 13 illustrates a configuration example of Doppler shifts of first radar section 10 ((a) in FIG. 13) and a configuration example of Doppler shifts of second radar section 10 ((b) of FIG. 13) when N_{sw}=2, N_{DM}(1)=3, N_{DM}(2)=4, and δ₁=δ₂=1.

In the example of FIG. 13, Δfd(1)=1/(8Tr) and Δfd(2)=1/(10Tr), and the ratio between Δfd(1) and Δfd(2) does not match an integer. Thus, configuration condition 2 of DDM intervals Δfd(q) is satisfied.

The configuration examples of DS amounts have been described above.

For example, DS sections 101 may set the DS amounts corresponding to transmission antennas 102 using the DDM intervals set as described above, and apply the phase rotations for applying the DS amounts to the chirp signals at respective chirp transmission periods.

For example, nth DS section 101 of qth radar section 10 applies, to the mth chirp signal as input, phase rotation Φ_{n,q} (m) for applying DS amount DOPₙ(q) different for each nth transmission antenna 102, and outputs the resultant signal. As a result, different Doppler shifts are applied to the transmission signals transmitted respectively from multiple transmission antennas 102.

Here, n is an integer of from 1 to Nt(q), m is an integer of from 1 to N_{c}, and q is 1 or 2.

For example, phase rotations Φ_{n,q}(m) for applying DS amounts DOPₙ(q) for DDM intervals Δfd(q) to TxSig transmitted from Nt(q) (e.g., Nt(q)=N_{DM}(q)) transmission antennas 102 are expressed by following Expression 7. Expression 8 represents DS amounts DOPₙ(q) for DDM intervals Δfd(q).

$$\begin{matrix}{ϕ}_{n , q} ( m ) = \{ 2 π {N}_{sw} {T}_{r} \times {DOP}_{n} ( q ) + Δ {ϕ}_{0} \} \times floor [ \frac{m - 1}{{N}_{sw}} ] + {Φ}_{0} \\ = \{ 2 π {N}_{sw} {T}_{r} \times {ϕ}_{0} \} Δ {f}_{d} ( q ) ( n - α ) + {Δϕ}_{0} \} \times floor [ \frac{m - 1}{{N}_{sw}} ] + {Φ}_{0}\end{matrix} \qquad ( Expression 7 )$$

$${DOP}_{n} ( q ) = Δ {f}_{d} ( q ) ( n - α ) \qquad ( Expression 8 )$$

In the expression, @0 is the initial phase and ΔΦ0 is a reference Doppler shift phase. Further, α is a coefficient for offsetting the DS amount for each DDM signal and a real value may be used for the coefficient. For example, when α=1, the DS amount for the first DDM signal is zero.

For example, when Nt(1)=Nt(2)=3, ΔΦ0=0, Φ0=0, δ₁=1, and δ₂=2, the DDM intervals are set to Δfd(1)=1/(4N_{sw}Tᵣ) and Δfd(2)=1/(5N_{sw}Tᵣ). Further, for example, when α=1, DS amount DOPₙ(q) corresponding to nth transmission antenna 102 is expressed by following Expression 9:

$${DOP}_{n} ( q ) = Δ {f}_{d} ( q ) ( n - 1 ) . \qquad ( Expression 9 )$$

Further, for example, phase rotations Φ_{n,q}(m) for applying DS amounts DOPₙ(q) different for nth (n=1, 2, 3) transmission antennas 102 to the mth chirp signal as input are expressed by following Expression 10:

$$\begin{matrix}{ϕ}_{1 , 1} ( m ) = 0 , {ϕ}_{2 , 1} ( m ) = \frac{π}{2} floor [ \frac{m - 1}{{N}_{sw}} ] , {ϕ}_{3 , 1} ( m ) = π floor [ \frac{m - 1}{{N}_{sw}} ] , \\ {ϕ}_{1 , 2} ( m ) = 0 , {ϕ}_{2 , 2} ( m ) = \frac{2 π}{5} floor [ \frac{m - 1}{{N}_{sw}} ] , {ϕ}_{3 , 2} ( m ) = \frac{4 π}{5} floor [ \frac{m - 1}{{N}_{sw}} ] .\end{matrix} \qquad ( Expression 10 )$$

For example, when first radar section 10 performs DDM transmission using number Nt of transmission antennas=3, first DS section 101 in first radar section 10 applies phase rotation Φ_{1,1}(m) to the chirp signal inputted from synchronizer 20 for each transmission period Tᵣ as shown in following Expression 11. The output of first DS section 101 is output from, for example, first transmission antenna 102 (Tx #1). Here, cp(t) denotes the chirp signal for each transmission period.

$$exp \{ j {ϕ}_{1 , 1} ( 1 ) \} cp ( t ) , exp \{ j {ϕ}_{1 , 1} ( 2 ) \} cp ( t ) , … , exp \{ j {ϕ}_{1 , 1} ( {N}_{c} ) \} cp ( t ) \qquad ( Expression 11 )$$

Further, for example, when second radar section 10 performs DDM transmission using number Nt=3 of transmission antennas, first DS section 101 in second radar section 10 applies phase rotation Φ_{1,2}(m) to the chirp signal inputted from synchronizer 20 for each transmission period Tᵣ as shown in following Expression 12. The output of first DS section 101 is output from, for example, first transmission antenna 102 (Tx #1).

$$exp \{ j {ϕ}_{1 , 2} ( 1 ) \} cp ( t ) , exp \{ j {ϕ}_{1 , 2} ( 2 ) \} cp ( t ) , … , exp \{ j {ϕ}_{1 , 2} ( {N}_{c} ) \} cp ( t ) \qquad ( Expression 12 )$$

The configuration examples of DS amounts have been described above.

Next, an exemplary operation of first CFAR section 210, second CFAR section 210, first demultiplexer 211, and second demultiplexer 211 in qth radar section 10 corresponding to the operation of DS sections 101 described above will be described.

For example, qth radar section 10 demultiplexes a first reflected wave signal from a reception signal in a transmission period in which the FDM transmission is performed, and demultiplexes, based on the first reflected wave signal, a second reflected wave signal and a third reflected wave signal from a reception signal in a transmission period in which the same-frequency transmission is performed.

### [Exemplary Operation of First CFAR Section 210]

For example, in order to receive the reflected wave signals in the FDM transmission, first CFAR section 210 of qth radar section 10 may perform the following operation.

For example, first CFAR section 210 may perform peak detection by searching, in power addition values of outputs from first DA sections 209 of first to Na(q)th analyzer 206, for a power peak that matches a DDM interval set for TxSig of qth radar section 10 for each R-Index and performing adaptive threshold processing (CFAR processing). For example, first CFAR section 210 performs CFAR processing combined with CFAR processing in two dimensions including a distance axis and a DFreq axis (corresponding to a relative velocity) or with one-dimensional CFAR processing in the peak detection (for example, processing disclosed in NPL 3 may be applied).

Here, for example, when DS section 101 sets δ_{q} to a positive integer, the interval of Δfd(q) or the interval of an integer multiple of Δfd(q) is used as the intervals between the DS amounts. In this case, q may be 1 or 2. Therefore, signals on which DDM is performed can be detected as aliasing at an interval of Δfd(q) in the DFreq region of the outputs of first DA section 209. By using such characteristics, for example, the operation of first CFAR section 210 can be simplified as follows.

For example, first CFAR section 210 of qth radar section 10 detects a Doppler peak by applying a threshold to a power addition value obtained by adding together the reception powers of the reflected wave signals for respective ranges (for example, ranges of Δfd(q)) within the DFreq range that is outputted from first DA sections 209 and subjected to the CFAR processing, the ranges corresponding to the intervals of the DS amounts applied respectively to TxSig.

For example, first CFAR section 210 performs the CFAR processing on the outputs from first DA sections 209 of first to Na(q)th analyzers 206 by calculating power addition value PowerDDM_{q}(f_{b}, f_{sdc}) obtained by adding power values Power_{q}FT(f_{b}, fₛ) at the intervals of Δfd(q) (for example, corresponding to N_{Δfd(q)}) as illustrated in following Expressions 13 and 14. Such CFAR processing is referred to as, for example, “Doppler domain compression CFAR processing,” and is referred to as “DC-CFAR.” DC-CFAR is described in, for example, PTL 4, and detailed explanation thereof is omitted.

$${Power DDM}_{q} ( {f}_{b} , {f}_{sdc} ) = {\sum }_{ndm = 1}^{{N}_{DM} ( q ) + {δ}_{q}} {Power FT}_{q}^{mono} ( {f}_{b} , {f}_{s d c} + ( ndm - 1 ) \times {N}_{Δ {f}_{d} ( q )} ) \qquad ( Expression 13 )$$

$${Power FT}_{q}^{mono} ( {f}_{b} , {f}_{s} ) = {\sum }_{z = 1}^{{N}_{a} ( q )} {\vert {VFT}_{z , q}^{mono} ( {f}_{b} , {f}_{s} ) \vert}^{2} \qquad ( Expression 14 )$$

In the expressions, f_{sdc}=−N_{VFT}/2, . . . , and −N_{VFT}/2+N_{Δfd(q)}−1 holds true and N_{Δfd(q)}=round (Δfd(q)/(1/(TᵣN_{c})) holds true. In addition, round(x) is an operator that rounds off real number x and outputs an integer value.

Accordingly, the range of DFreq subjected to the CFAR processing in first CFAR section 210 can be set (for example, reduced) to 1/(Nt(q)+δ_{q})=1/(N_{DM}(q)+δ_{q}) of the entire range (for example, the range of from −N_{VFT}/2 to N_{VFT}/2−1). It is thus possible to reduce the computational amount of the CFAR processing.

For example, first CFAR section 210 adaptively sets a threshold, and outputs, to first demultiplexer 211, f_{bp}^{Mono} and f_{sdcp}^{mono} as fₛₚ^{Mono} that provide reception power greater than the threshold, and, the reception power information (PowerFT_{q}^{mono}(f_{bp}^{mono}, f_{sdcp}^{mono}+ (ndm−1)×N_{Δfd(q)})). Here, ndm is an integer of from 1 to N_{DM}(q)+δ_{q}.

### [Exemplary Operation of First Demultiplexer 211]

First demultiplexer 211 of qth radar section 10 performs the following operations, for example, based on f_{bp}^{mono}, f_{sdcp}^{mono}, and the reception power information inputted from first CFAR section 210.

<Case of δ_{q}>0>

In first demultiplexer 211, for example, DFreq of the target object may be determined primarily, assuming that DFreq is within −1/(2TᵣN_{sw})≤f_{d}<1/(2TᵣN_{sw}). Since DFreq of the target object is finally determined by subsequent determiner 212, the determination by first demultiplexer 211 is also referred to as “provisional determination” or “provisional decision.” Further, a large difference between, on one hand, the reception levels for top N_{DM}(q) DF-Indices of reception power and, on the other hand, the reception levels for 8 DF-Indices different from the top N_{DM} DF-Indices of reception power (for example, the difference being equal to or greater than the threshold) may be used. For example, first demultiplexer 211 compares the reception power information inputted from first CFAR sections 210 and primarily determines DFreq. Note that an exemplary operation of first demultiplexer 211 is disclosed in, for example, PTL 3, and therefore description of the exemplary operation is omitted here.

For example, first demultiplexer 211 associates the DS amounts of the transmitted DDM signals with f_{sdcp}^{mono}+(ndm−1)×N_{Δfd(q)} based on the relation between δ_{q} DF-Indices of a lower reception level and top N_{DM} DF-Indices of a higher reception power, and outputs it as DDM-signal demultiplexing index information f_{Tx}(q)=(f_{dmlTx #1}(q), . . . , f_{dmlTx #NDM}(q)) to second demultiplexer 211 and determiner 212.

Here, f_{dmlTx #n}(q) indicates DF-Index of the reflected wave signal of TxSig transmitted from nth transmission antenna 102 (Tx #n) of qth radar section 10.

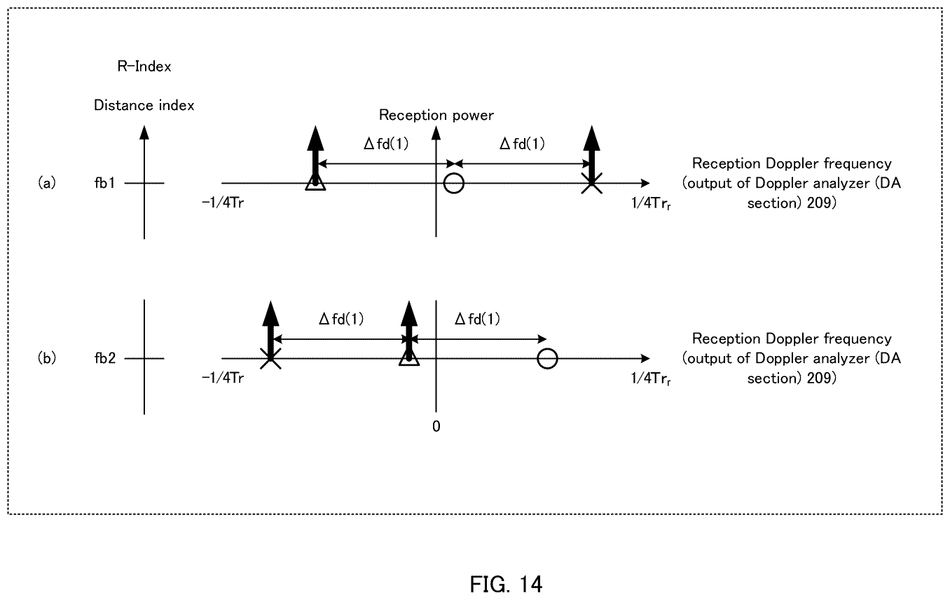

FIG. 14 illustrates an example of an output (for example, received DFreq) of DA section 209 in a case where a reflected wave signal of TxSig from first radar section 10 is received. In FIG. 14, the vertical axis represents the distance axis, and the horizontal axis represents the DFreq axis.

For example, when a DFreq peak component (hereinafter, referred to as “DF-Peak”) corresponding to interval Δfd(1) or an integer multiple of interval Δfd(1) are observed at R-Index (fb1 or fb2) illustrated in FIG. 14, first demultiplexer 211 can distinguish (for example, detect) that these DFreq peak components are reflected wave signals of TxSig transmitted from first radar section 10.

Further, for example, in FIG. 14, δ₁ (=1) DF-Index for a lower reception level is indicated by mark “◯,” and top N_{DM}(=2) DF-Peaks of reception power are indicated by marks “x” and “Δ.” For example, since the DF-Indices (mark “◯” in FIG. 33) that do not match the interval of Δfd(1) is uniquely determined in the range of −1/(2TᵣN_{sw})≤f_{d}<1/(2TᵣN_{sw}), first demultiplexer 211 can provisionally determine unique DFreq of the target object in the above range.

Further, first demultiplexer 211 can determine the association between DFreq and transmission antennas 102, for example, based on the magnitude relationship between DF-Indices (mark “◯”) and DF-Peaks (mark “x”) that match other intervals of Δfd(1).

By way of example, a description will be given of a case in which N_{DM}(1)=2 at R-Index=fb1 at (a) in FIG. 14, and TxSig is transmitted by assigning Tx #1 to DFreq (mark “x”) higher by Δfd(1) than the DF-Index (mark “◯”), and TxSig is transmitted by assigning Tx #2 to DFreq (mark “Δ”) lower by Δfd(1) than DF-Index (mark “◯”).

In this case, at (a) in FIG. 14, first demultiplexer 211, for example, detects δ₁ DF-Index for a lower reception level (mark “◯”), and can thus determine that DF-Peak (mark “x”) higher by Δfd(1) than DFreq (mark “◯”) corresponds to Tx #1 and DF-Peak (mark “Δ”) lower by Δfd(1) than DFreq (mark “◯”) corresponds to Tx #2.

Likewise, it is, for example, assumed that at R-Index=fb2 at (b) in FIG. 14, the same assignment of the DDM signals as at (a) is performed. Since the observable DFreq range in DA sections 209 is a range of −1/(2TᵣN_{sw})≤f_{d}<1/(2TᵣN_{sw}), for example, DFreq can be observed as aliasing in a lower frequency range when DFreq (mark “x”) higher by Δfd(1) than DF-Index (mark “◯”) exceeds 1/(2TᵣN_{sw}). Since first demultiplexer 211 can assume generation of aliasing in advance, it can be determined that, for example, DF-Peak (mark “Δ”) lower by Δfd(1) than DF-Index (mark “◯”) corresponds to Tx #2, and further, DF-Peak (mark “x”) even lower by Δfd(1) corresponds to Tx #1.

### [Exemplary Operation of Second CFAR Section 210]

For example, second CFAR section 210 of qth radar section 10 may perform the following operations in order to receive a reflected wave signal of TxSig from qth radar section 10 and a reflected wave signal of TxSig from geth radar section 10 that are transmitted in the same-frequency transmission in the BMS configuration.

Here, “qe” represents a radar number of radar section 10 that differs from qth radar section 10. For example, “qe” may be 2 in the case of first radar section 10 (q=1), or “qe” may be 1 in the case of second radar section 10 (q=2).

<(I) Case where DS Section 101 Sets Intervals of Δfd(q) in the BMS Configuration to the Same Value>

Second CFAR section 210 may perform peak detection by, for example, searching, in the power addition values of outputs from second DA sections 209 of first to Na(g)th analyzers 206, for a power peak that matches the DDM interval set for TxSig of transmitter 100 of each of qth radar section 10 and geth radar section 10 for each R-Index, and performing adaptive threshold processing.

Here, for example, when δ_{q} is set to a positive integer in DS sections 101, an interval of Δfd(q) or an interval of an integer multiple of Δfd(q) is used as an interval of the DS amounts (where q may be 1 or 2 and Δfd(1) may be equal to Δfd(2)). Therefore, signals on which DDM is performed can be detected as aliasing at an interval of Δfd(q) in the DFreq domain of the outputs of second DA sections 209. By using such characteristics, for example, the DC-CFAR processing described for the operation of first CFAR section 210 can be applied. For example, second CFAR section 210 performs the DC-CFAR processing by calculating a power addition value using outputs “VFT_{z,q}^{Mix}(f_{b}, fₛ)” from second DA sections 209 of first to Na(q)th analyzers 206 instead of “VFT_{z,q}^{Mono}(f_{b}, fₛ)” in Expressions 13 and 14.

Subsequent operations in the case where the DC-CFAR processing is used in CFAR section 210 will be described below. In this instance, second CFAR section 210 adaptively sets the threshold, and outputs R-Index f_{bp}^{mix}, DFreq index f_{sdcp}^{mix} and the reception power information (PowerFT_{q}^{mix} (f_{bp}^{mix}, f_{sdcp}^{mix}+(ndm−1)×N_{Δfd(q)}) that provide reception power greater than the threshold to second demultiplexer 211. Here, ndm is an integer of from 1 to N_{DM}(q)+δ_{q}. In the following, the CFAR processing in above-described second CFAR section 210 is also referred to as “mono- & multi-reception CFAR.”

<(ii) Case where Intervals of Δfd(q) in the BMS Configuration are Set to Different Values in DS Section 101>

In order to receive a reflected wave signal of TxSig from qeth radar section 10, second CFAR section 210 may perform the same operation as first CFAR section 210 of geth radar section 10, for example, using a power addition value based on outputs VFT_{z,q}^{Mix}(f_{b}, fₛ) (z=1 to Na(q)) from second DA sections 209 of first to Na(q)th analyzers 206. For example, second CFAR section 210 may perform peak detection by searching for a power peak that matches DDM interval Δfd(qe) set for TxSig from qeth radar section 10 and performing adaptive threshold processing. In the following, the CFAR processing in above-described second CFAR section 210 is also referred to as “multi-reception CFAR.”

Subsequent operations in the case where the DC-CFAR processing is used in CFAR section 210 will be described below. Second CFAR section 210 outputs R-Index f_{bp}^{mix} and DF-Index f_{sdcp}^{mix} for which the peak detection is performed by the multi-reception CFAR and the reception power information (PowerFT_{q}^{mix}(f_{bp}^{mix}, f_{sdcp}^{mix}+(ndm−1)×N_{Δfd(qe)})) to second demultiplexer 211. Here, ndm is an integer of from 1 to N_{DM}(qe)+δ_{qe}.

### [Exemplary Operation of Second Demultiplexer 211]

Second demultiplexer 211 of qth radar section 10 performs DDM demultiplexing on the second reflected wave signals in the MNS configuration and the third reflected wave signals in the BMS configuration, for example, using the outputs of first demultiplexer 211, second CFAR section 210, and second DA section 209.

Here, the first reflected wave signals in the MNS configuration are demultiplexed by first demultiplexer 211. Therefore, second demultiplexer 211 regards the outputs of second DA section 209 corresponding to DDM-signal demultiplexing index information f_{Tx}(q) as the second reflected wave signals, and outputs it to determiner 212. Hereinafter, the outputs regarded as the second reflected wave signals are also referred to as “second-demultiplexer mono-reception signal outputs.”

When the center frequency of TxSig from qth radar section 10 as the MNS configuration (hereinafter, referred to as the center frequency in the MNS configuration) differs from the center frequency of TxSig from qth radar section 10 as the BMS configuration (hereinafter, referred to as the center frequency in the BMS configuration), DF-Index may change depending on the relative velocity of the target object with respect to radar apparatus 1. Therefore, for example, second demultiplexer 211 regards a signal included in a range of change of DF-Index within the expected relative-velocity range of the target object as the second reflected wave signal, and outputs it as the second-demultiplexer mono-reception signal output to determiner 212.

Further, at the time of outputting the second-demultiplexer mono-reception signal output, in a case where the Doppler shift configuration in DS section 101 in each of the plurality of radar sections 10 includes patterns of DS amounts which do not match each other even with cyclic shifting (for example, configuration example 1-a-3 or configuration example 1-a-4), in a case where the numbers of DDM are different (for example, configuration example 1-b-1), or in a case where the intervals of Δfd(q) are set to different values in the BMS configuration (for example, configuration example 2-a-1 or configuration example 2-a-2), second demultiplexer 211 may determine whether or not the pattern of DS amounts matches the pattern of DS amounts of the Doppler shift configuration in the above MNS configuration, whether or not the numbers of DDM match each other, or whether or not the interval matches the interval of Δfd(q). By such determination, second demultiplexer 211 can suppress the third reflected wave signal from being regarded erroneously as the second reflected wave signal.

Meanwhile, second demultiplexer 211 treats, as the third reflected wave signal, an output from second CFAR section 210 that does not match (or does not correspond to) DDM-signal demultiplexing index information f_{Tx}(q), and outputs the signal subjected to the DDM demultiplexing to second angle measurer 213. Hereinafter, the output subjected to the DDM multiplexing in second demultiplexer 211 as described above is also referred to as “second-demultiplexer multi-reception-signal output.”

The latter DDM demultiplexing operation is, for example, a DDM demultiplexing operation based on information inputted from second CFAR section 210 that does not match DDM-signal demultiplexing index information f_{Tx}(q) (for example, that allows consideration as multi-reception).

Therefore, the operation of second demultiplexer 211 is the same as the operation performed in first demultiplexer 211 using the information input from second CFAR section 210 that allows consideration as the multi-reception, instead of the information input from first CFAR section 210. Therefore, a description of such an operation of second demultiplexer 211 will be omitted.

For example, second demultiplexer 211 associates the DS amounts of the transmitted DDM signals with f_{sdcp}^{mix}+(ndm−1)×N_{Δfd(ge)} based on the relation between δ_{qe} DF-Indices of a lower reception level and top N_{DM}(qe) DF-Indices of a higher reception power, and outputs it as DDM-signal demultiplexing index information f_{Tx}(qe) to second angle measurer 213. Here, f_{Tx}(qe) indicates DF-Index of the reflected wave signal of TxSig transmitted from each transmission antenna 102 of geth radar section 10.

Further, second demultiplexer 211 outputs, for example, information on the demultiplexed second-demultiplexer multi-reception signal to second angle measurer 213. The information about the demultiplexed signals may include, for example, R-Index and the DDM-signal demultiplexing index information corresponding to the second-demultiplexer multi-reception signal. The outputs of second demultiplexer 211 may include an output from second DA section 209. Note that the detectable DFreq range is ±1/(2TᵣN_{sw}).

### [Exemplary Operation of Determiner 212]

For example, determiner 212 performs DFreq determination (for example, DFreq aliasing determination) based on the first reflected wave signals and the second reflected wave signals.

For example, determiner 212 determines DFreq based on a phase difference between the reception signals of the second reflected wave signals in the MNS configuration demultiplexed by first demultiplexer 211 and second demultiplexer 211 (for example, the case where “transmission condition 1” to be described later is satisfied) or a DFreq difference (for example, the case where “transmission condition 2” to be described later is satisfied). As a result, the observable DFreq range in radar apparatus 1 can be enlarged (for example, the DFreq range can be enlarged to ±1/(2Tr)), and the detectable maximum DFreq can be increased. Note that the Doppler determination result obtained by enlarging the DFreq range observable by determiner 212 together with the outputs from first demultiplexer 211 and second demultiplexer 211 may be output, for example, to first angle measurer 213.

Transmission condition 1 and transmission condition 2 will be described below.

### <Transmission Condition 1>

Transmission condition 1 is a case where the center frequency (fc^{mono}) in the MNS configuration is identical to the center frequency (fc^{mix}) in the BMS configuration. For example, transmission condition 1 is a case where the center frequency of TxSig in the transmission period in which FDM transmission is performed is identical to the center frequency of TxSig in the transmission period in which the same-frequency transmission is performed.

For example, when DA section 209 assumes relative velocity Vₜ of a target object for which the DFreq range is ±1/(2Tr) with respect to unambiguously observable DFreq (for example, a frequency range±1/(2TᵣN_{sw})), determiner 212 determines DFreq of the target object (for example, an aliasing of DFreq) based on the phase difference between the output of second DA section 209 and the output of first DA section 209 in DDM-signal demultiplexing index information f_{Tx}(q). As a result, the DFreq range detectable by radar apparatus 1 can be expanded (for example, the frequency range can be expanded to ±1/(2Tr)).

For example, when N_{sw}=2 and when DFreq in the frequency range±1/(2TᵣN_{sw}) corresponding to the DDM-signal demultiplexing index that is the output of first demultiplexer 211 is fd1, DFreq of the target object may be fd1 or fd1±1/(N_{sw}Tᵣ) considering DFreq aliasing in the frequency range±1/(2Tr).

For example, the phases of reception signals for DF-Indices corresponding to DFreq fd1 in first DA section 209 and second DA section 209 are denoted as φ₁(fd1) and Φ₂(fd1), respectively. For example, DFreq aliasing occurs and such DFreq is determined as fd1±1/(N_{sw}Tᵣ) when phase difference ΔΦ(fd1)=φ₂(fd1)−φ₁(fd1)−2πfd1Tr between φ₁(fd1) and φ₂(fd1) is ΔΦ(fd1)=±1/(N_{sw}Tᵣ)×2πTr=±(2π/N_{sw})=±π. On the other hand, when ΔΦ(fd1)=0, it is determined that DFreq aliasing does not occur and DFreq is fd1.

### <Transmission Condition 2>

Transmission condition 2 is a case where the center frequency in the MNS configuration differs from the center frequency in the BMS configuration. For example, transmission condition 2 is a case where the center frequency of TxSig in the transmission period in which FDM transmission is performed differs from the center frequency of TxSig in the transmission period in which the same-frequency transmission is performed.

For example, when DA section 209 assumes relative velocity Vₜ of a target object for which the DFreq range is ±1/(2Tr) with respect to unambiguously observable DFreq (for example, a frequency range±1/(2TᵣN_{sw})), determiner 212 determines DFreq of the target object (for example, an aliasing of DFreq) based on the difference in DF-Index between the output of second DA section 209 and the output of first DA section 209 in DDM-signal demultiplexing index information f_{Tx}(q). As a result, the DFreq range that can be observed in radar apparatus 1 can be expanded (for example, the frequency range is expanded to ±1/(2Tr)).

For example, since the operation of determiner 212 using a feature that the DF-Index information of second DA section 209 changes according to DDM-signal demultiplexing index information f_{Tx}(q) depending on center frequency difference Δfc=(fc^{mono})−(fcₘᵢₓ) and relative velocity vₜ of the target object with respect to radar apparatus 1 is described in, for example, Japanese Patent Application Laid-Open No. 2023-024253, detailed explanation thereof will be omitted. For example, the frequency difference in center frequency is set as given by following Expression 15, and thus, determiner 212 can perform DFreq aliasing determination in the DFreq range±1/(2Tr):

$$Δ {f}_{c} = {f}_{c}^{mono} - {f}_{c}^{mix} > {f}_{c}^{mono} / {N}_{c} . \qquad ( Expression 15 )$$

For this reason, in second DA section 209, when a predetermined number of DF-Indices change and a Doppler peak is detected with respect to the DDM-signal demultiplexing index information, DFreq aliasing also occurs. Therefore, determiner 212 makes determination as DFreq considering DFreq aliasing based on the amount of change of DFreq. On the other hand, when a Doppler peak is detected for the same DF-Index as in second DA section 209 with respect to the DDM-signal demultiplexing index information, DFreq aliasing does not occur. Therefore, determiner 212 determines DFreq not causing DFreq aliasing.

In one exemplary embodiment of the present disclosure, transmission period Tᵣ may be set to be, for example, about several hundred us or less, and a TxSig transmission interval may be set to be relatively short. Thus, for example, even in the case of chirp signals having different center frequencies, the frequencies (for example, beat frequency indices) of beat signals of reflected wave signals do not change. Accordingly, radar apparatus 1 can detect the change as a change in DFreq. Note that transmission period Tᵣ is not limited to the above-described embodiment.

### [Exemplary Operation of First Angle Measurer 213]

For example, first angle measurer 213 of qth radar section 10 performs angle measurement of the target object using the second reflected wave signals based on information inputted from first demultiplexer 211 and second demultiplexer 211 via determiner 212 (for example, R-Index f_{bp}(q) and DDM-signal demultiplexing index information f_{Tx}(q)). For example, first angle measurer 213 may perform angle measurement based on DFreq aliasing determination by determiner 212.

For example, first angle measurer 213 performs angle measurement by extracting the outputs of DA sections 209 based on f_{bp}(q) and DDM-signal demultiplexing index information f_{Tx}(q), and generating qth virtual reception array correlation vector h_{q}(f_{bp}(q), f_{Tx}(q)) of first angle measurer 213 including Nt(q)×Na(q) elements that are the product of number Nt(q) of transmission antennas and number Na(q) of reception antennas. Here, for example, q=1, 2.

Note that first angle measurer 213 may perform angle measurement for each of the outputs of first and second DA sections 209, or may perform angle measurement using a combined result using in-phase addition or power addition.

Note that there are various methods for angle measurement algorithms. For example, the estimation method disclosed in NPL 4 may be used (the same applies to the angle measurer below).

Through the above-described operations, first angle measurer 213 of qth radar section 10 may output, for example, an angle measurement value for f_{bp}(q) and DDM demultiplexing index information f_{Tx}(q) as a positioning output.

In addition, f_{bp}(q) may be converted into distance information by using Expression 1 and outputted.

Further, DFreq of the target object for f_{bp}(q) determined by determiner 212 may be outputted. Since the DS amounts applied by DS sections 101 at the time of transmission are known to each of transmission antennas 102, first angle measurer 213 may output DFreq of the target object based on the DDM-signal demultiplexing index information and the output of determiner 212.

### [Exemplary Operation of Second Angle Measurer 213]

Second angle measurer 213 of qth radar section 10 performs angle measurement of the target object based on, for example, information (for example, R-Index f_{bp}(qe)) inputted from second demultiplexer 211 and DDM-signal demultiplexing index information f_{Tx}(qe). For example, second angle measurer 213 may perform angle measurement based on the reflected wave signal of TxSig from qeth radar section 10, which is demultiplexed in second demultiplexer 211.

For example, second angle measurer 213 performs angle measurement by extracting the outputs of DA sections 209 based on f_{bp}(qe) and DDM-signal demultiplexing index information f_{Tx}(qe), and generating qeth virtual reception array correlation matrix H_{qe}(f_{bp}(qe), f_{Tx}(qe)) of second angle measurer 213 that is composed of a Nt(qe)×Na(q)-order matrix. Here, for example, qe=1, 2.

Second angle measurer 213 of qth radar section 10 may output, for example, the direction of departure as an angle measurement value (for example, a positioning output) to integrator 30.

Further, second angle measurer 213 of qth radar section 10 may output, for example, the angle measurement to integrator 30 as a measurement angle value (for example, a positioning output) in the direction of arrival. As the angle measurement, for example, the angle measurement in the BMS configuration described in NPL 3 or 5 may be used.

Through the above operations, second angle measurer 213 of qth radar section 10 may output, for example, the direction-of-departure angle measurement value and the direction-of-arrival angle measurement value for f_{bp}(qe) and DDM-signal demultiplexing index information f_{Tx}(qe) as the positioning output.

In addition, f_{bp}(qe) may be converted into distance information by using Expression 2 and outputted.

Since the DS amounts applied by DS sections 101 at the time of transmission are known to each of transmission antennas 102, second angle measurer 213 may output DFreq of the target object based on the DDM-signal demultiplexing index information.

A method for estimating a target-object position in a radar having a BMS configuration is described in, for example, NPL 5. Thus, a detailed description of the estimation method will be omitted. Note that, in the above-described example, an example in which angle measurer 213 measures the direction of departure or arrival has been described, but the present disclosure is not limited thereto, and it is also possible to measure the angle in the elevation angle direction or the angle in the direction of departure or arrival and the elevation angle direction by the antenna arrangement of each radar. For example, angle measurer 213 may calculate the direction of departure or arrival and the elevation angle direction as the angle measurement values, and may use them as the positioning output.

The exemplary operation of second angle measurer 213 has been described above.

In FIG. 2, integrator 30 performs positioning of a target object by integrating the positioning outputs of first angle measurer 213 and second angle measurer 213 from first radar section 10 and the positioning outputs of first angle measurer 213 and second angle measurer 213 from second radar section 10.

For example, integrator 30 may determine the type of the target object based on a consistency between a positioning result of second angle measurer 213 of first radar section 10 and a positioning result of second angle measurer 213 of second radar section 10, which are the positioning results in the BMS configuration. For example, integrator 30 may utilize the tendency of a high consistency in the case of poles (metal poles) and a low consistency at a reflection point in the case of a target object having a large horizontal dimension, such as a wall.

Further, for example, when a detected area overlap between the positioning output of first angle measurer 213 of first radar section 10 and the positioning output of first angle measurer 213 of second radar section 10, which are the positioning results in the MNS configuration, integrator 30 may output highly consistent components in both of estimation results. For example, integrator 30 may not output less consistent components between both of the estimation results. In this case, integrator 30 can remove multipath reflection or the like that becomes a virtual image.

Note that integrator 30 may output the positioning output (or the positioning result) to, for example, a control apparatus (ECU or the like) of a vehicle in the case of an in-vehicle radar, or to an infrastructure control apparatus in the case of an infrastructure radar, which are not illustrated.

As described above, in the present embodiment, radar apparatus 1 includes first radar section 10 that transmits the first radar transmission signal and second radar section 10 that transmits the second radar transmission signal. Here, the plurality of transmission periods in which the first radar transmission signal and the second radar transmission signal are transmitted include a transmission period in which the FDM transmission of the first radar transmission signal and the second radar transmission signal is performed and a transmission period in which the same-frequency transmission of the first radar transmission signal and the second radar transmission signal is performed. For example, in a plurality of transmission periods, the transmission period in which FDM transmission is performed and the transmission period in which the same-frequency transmission is performed are alternately configured.

As a result, radar apparatus 1 alternately switches the FDM transmission and the same-frequency transmission as inter-BMS multiplexing transmission at every transmission period of the chirp signal, thereby maintaining the radar detection performance (for example, the detectable Doppler detection range) in the MNS configuration, enabling inter-BMS simultaneous multiplexing transmission in addition to the simultaneous multiplexing transmission in the MNS configuration, and achieving a time-saving effect required for radar distance measurement. Therefore, according to the present embodiment, the target object can be efficiently detected in radar apparatus 1.

Note that while the Doppler detection range based on the output of second demultiplexer 211 is ±1/(2TᵣN_{sw}) for detection of DFreq in the BMS configuration in the present embodiment, the Doppler detection result in the MNS configuration may be used when the target object can be regarded as the same target between the BMS configuration and the MNS configuration. Thus, it is possible to expand the Doppler detection range to ±1/(2Tr) in the BMS configuration for performing Doppler detection based on the output of determiner 212.

Further, in the present embodiment, as illustrated in FIG. 4, the operation of first radar section 10 and second radar section 10 is described as an exemplary case where controller 304 configures the modulation parameters of the chirp signal such that the FDM transmission and the same-frequency transmission are alternately switched for each transmission period Tᵣ in the BMS configuration, but the present disclosure is not limited thereto.

Hereinafter, another example (variation) of the operation of first radar section 10 and second radar section 10 performed when switching transmission between the FDM transmission and same-frequency transmission is used in the BMS configuration will be described. In the following, operations different from the operation of the above-described embodiment will be mainly described.

### (Variation 1)

In Variation 1, in a plurality of transmission periods in which TxSig is transmitted, a transmission period in which the same-frequency transmission is performed is continuously set after a transmission period in which the FDM transmission is performed.

For example, controller 304 of synchronizer 20 may configure parameters related to a chirp signal such that the center frequency of the chirp signal is varied at every predetermined transmission period such that the same-frequency transmission is repeated (N_{sw}−1) times after the FDM transmission in the BMS configuration.

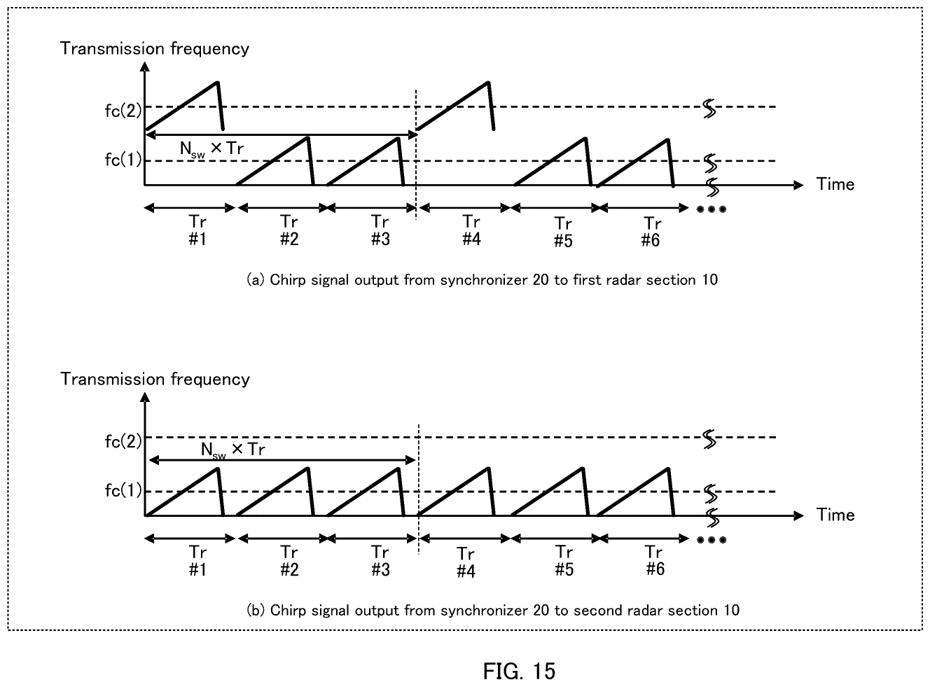

Part (a) in FIG. 15 illustrates an exemplary chirp signal in first radar section 10 for which a transmission period in which two same-frequency transmissions are performed is configured after a transmission period in which the FDM transmission is performed, in a case where, in the BMS configuration, a transmission cycle at which the FDM transmission and the same-frequency transmission are switched is 3Tr (N_{sw}=3). Part (b) in FIG. 15 illustrates an exemplary chirp signal in second radar section 10, which has the same configuration as at (a) in FIG. 15, except that the chirp signal having the same center frequency is transmitted in the FDM transmission and the same-frequency transmission.

For example, among 3Tr of transmission periods Tᵣ #1 to Tᵣ #3 illustrated at (a) and (b) in FIG. 15, the FDM transmission is performed in transmission period Tᵣ #1, and the same-frequency transmission is performed in transmission periods Tᵣ #2 and Tᵣ #3. The same applies to 3Tr of transmission periods Tᵣ #4 to Tᵣ #6 illustrated at (a) in FIG. 15 and the subsequent transmission periods.

As illustrated in FIG. 15, when the same-frequency transmissions are repeated (N_{sw}−1) times between BMS configurations, it is possible not only to achieve the advantages of the above-described embodiment but also to increase the detectable DFreq for the radar reception signal between the BMS configurations.

The subsequent operations of transmitter 100 of radar section 10 are the same as those of the above-described embodiment.

Next, an exemplary operation of receiver 200a according to Variation 1 will be described.

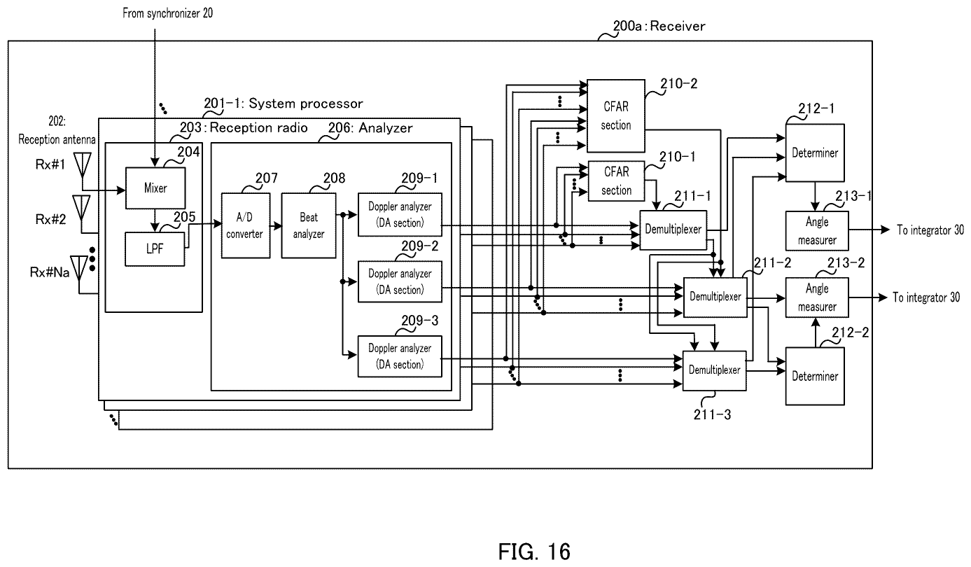

In receiver 200a illustrated in FIG. 16, DA section 209 of zth analyzer 206 performs Doppler analysis for each R-Index f_{b} by using BF responses obtained by N_{C} chirp pulse transmissions of the chirp signal.

Hereinafter, as illustrated in FIG. 15, an exemplary operation of DA section 209 performed when the same-frequency transmission is repeatedly transmitted (N_{sw}−1) times after the FDM transmission in the BMS configuration will be described.

In this instance, DA section 209 of zth analyzer 206 performs Doppler analysis for each f_{b} by using BF responses by which a reception signal of FDM transmission in the BMS configuration is obtained (e.g., BF responses RFT_{z}(f_{b}, m) which provide mod (m−1, N_{sw})=0) among BF responses obtained by transmission of the mth chirp signal. Here, mod (x, y) is a remainder operator, and a remainder obtained by dividing integer x by integer y is outputted. Hereinafter, DA section 209 that performs the above-described operation is also referred to as “first Doppler analyzer 209 (Doppler analyzer (DA section) 209-1)” or “mono-reception Doppler analyzer (DA section).”

In addition, DA section 209 of zth analyzer 206 performs Doppler analysis for each f_{b} by using BF responses by which a reception signal of the same-frequency transmission in the BMS configuration is obtained (e.g., BF responses RFT_{z}(f_{b}, m) which provide mod (m−1, N_{sw})=1, 2, . . . , and N_{sw}−1) among BF responses obtained by transmission of the mth chirp signal. DA sections 209 that perform the above operation are referred to as “second to N_{sw}th Doppler analyzers (DA sections) 209.” Second to N_{sw}th DA sections 209 are also referred to as “first to (N_{sw}−1)th mono- & multi-reception Doppler analyzers (DA sections),” respectively.

Receiver 200a illustrated in FIG. 16 illustrates an exemplary case where N_{sw} is 3, and includes first DA section 209, which is a mono-reception DA section, and second and third DA sections 209, which are first and second mono- & multi-reception DA sections. Second DA section 209 performs Doppler analysis using BF responses providing mod (m−1, N_{sw})=1. Similarly, third DA section 209 performs Doppler analysis using BF responses providing mod (m−1, N_{sw})=2.

As described above, uth DA section 209 performs the Doppler analysis using BF responses providing mod (m−1, N_{sw})=u−1.

Here, the output of uth DA section 209 is expressed by following Expression 16:

$${VFT}_{z , q}^{( u )} ( {f}_{b} , {f}_{s} ) = {\sum }_{s = 0}^{{N}_{VFT - 1}} {RFT}_{z , q} ( {f}_{b} , {N}_{sw} \times s + u ) exp [ - \frac{j 2 π {sf}_{s}}{{N}_{VFT}} ] . \qquad ( Expression 15 )$$

In Expression 16, VFT_{z,q}⁽¹⁾(f_{b}, fₛ) is an output of the mono-reception DA section, and is also referred to as, for example, VFT_{z,q}^{Mono(1)}(f_{b}, fₛ).

Second to N_{sw}th DA sections 209 are mono- & multi-reception DA sections, and VFT_{z,q}^{(u)}(f_{b}, fₛ) is outputs of the mono- & multi-reception DA sections, and are also referred to as VFT_{z,q}^{Mix(u)}(f_{b}, fₛ), for example.

In FIG. 16, for example, first CFAR section 210 performs the same process as first CFAR section 210 of the above-described embodiment.

In addition, in FIG. 16, for example, second CFAR section 210 selectively extracts local peaks of the third reflected wave signals by using the power addition value of the reception power values of the outputs (VFT_{z,q}^{Mix(u)}(f_{b}, fₛ) where z=1 to Na(q)) of the mono-& multi-reception DA sections among DA sections 209 of first to Na(q)th analyzers 206. Here, u=2 to N_{sw}. Note that the local-peak extraction processing in second CFAR section 210 may be the same process as in the above-described embodiment. For example, second CFAR section 210 may extract f_{bp}^{Mix} and DF-Index f_{sdcp}^{Mix} extracted by the CFAR processing that provide the local peak signals and may output them to second to N_{sw}th demultiplexers 211.

Third to N_{sw}th demultiplexers 211 (or demultiplexers 211-3 to 211-N_{sw}) differ in operation from the operation of second demultiplexer 211 of the above-described embodiment, in that the outputs of third to N_{sw}th DA sections 209 are used instead of the outputs of second DA section 209, but is the same as in the above embodiment, and thus the explanation of the operation is omitted.

Similarly to second demultiplexer 211, third to N_{sw}th demultiplexers 211 output, for example, information regarding the information for reception and demultiplexing of the second reflected wave signal (also referred to as “third-to-N_{sw}th-demultiplexer mono-reception-signal output”), to first determiner 212 (or determiner 212-1 or the “mono-reception-signal determiner”).

Note that the information regarding the second-to-N_{sw}th-demultiplexer mono-reception signal outputs may include, for example, R-Indices and DDM-signal demultiplexing index information corresponding to the second to N_{sw}th demultiplexer mono-reception signals and outputs from second to N_{sw}th DA sections 209.

In addition, second to N_{sw}th demultiplexers 211 output information for reception and demultiplexing of the third reflected wave signal (for example, also referred to as “second-to-N_{sw}th-demultiplexer multi-reception signal output”) to second determiner 212 (or determiner 212-2 or “multi-reception signal determiner”). The second-to-N_{sw}th-demultiplexer multi-reception-signal outputs may include outputs from second to N_{sw}th DA sections 209.

Note that the information regarding the second-to-N_{sw}th-demultiplexer multi-reception signal outputs may include, for example, R-Indices and DDM-signal demultiplexing index information corresponding to the second to N_{sw}th demultiplexer multi-reception signals and outputs from second to N_{sw}th DA sections 209.

First determiner 212 (or referred to as determiner 212-1) may perform the same operation as that of determiner 212 of the above-described embodiment.

For example, first determiner 212 determines DFreq based on the phase difference (for example, in the case where transmission condition 1 is satisfied) or DFreq difference (for example, in the case where transmission condition 2 is satisfied) of the reception signals of the second reflected wave signals demultiplexed by first to N_{sw}th demultiplexers 211. As a result, the DFreq range that can be observed in radar apparatus 1 (receiver 200a) can be expanded to, for example, the frequency range±1/(2Tr), and detectable maximum DFreq can also be increased. The Doppler determination result by first determiner 212 for which the observable DFreq range is expanded may be output to first angle measurer 213, for example, together with the input information from first to N_{sw}th demultiplexers 211.

Further, first determiner 212 may determine DFreq by combining the same operation as that in the above-described embodiment and the following operation. The DFreq determination accuracy can be improved by the following combination.

Alternatively, first determiner 212 may perform Doppler aliasing determination by applying the following operation. In this case, first determiner 212 can perform DFreq aliasing determination either using the frequency difference not satisfying transmission condition 2 (the condition of the center frequency difference Δfc=(fc^{mono})−(fc^{mix})) or using the FDM transmission in the BMS configuration. Therefore, for example, even when the frequency band that can be assigned for radar apparatus 1 is narrow, the same effects as those of the above-described embodiment can be obtained by applying Variation 1.

The center frequency in the MNS configuration obtained by demultiplexing in second to N_{sw}th demultiplexers 211 is the same. Accordingly, first determiner 212 determines DFreq based on the phase differences between the reception signals of the reflected wave signals of TxSig. As a result, the DFreq range that can be observed in radar apparatus 1 (receiver 200a) can be expanded to, for example, the frequency range±1/(2Tr), and detectable maximum DFreq can also be increased.

On the assumption of relative velocity vₜ of the target object for which the DFreq range is, for example, ±1/(2Tr) with respect to DFreq (for example, the frequency range±1/(2TᵣN_{sw})) that can be observed without ambiguity in second to N_{sw}th DA section 209, first determiner 212 may determine DFreq based on the phase difference between the outputs of second to N_{sw}th DA sections 209 in the DDM-signal demultiplexing index information that is the outputs from second to N_{sw}th demultiplexers 211. Thus, the DFreq range that can be observed in radar apparatus 1 (receiver 200a) can be expanded (for example, the frequency range can be expanded to ±1/(2Tr)).

For example, when DFreq in the frequency range±1/(2TᵣN_{sw}) corresponding to the DDM-signal demultiplexing indices that are the outputs of second and third demultiplexers 211 is fd1, there is a possibility that DFreq of the target object is fd1 or fd1±n/(N_{sw}Tᵣ) in view of DFreq aliasing in the frequency range±1/(2Tr) (for example, n=1 to N_{sw}−1).

For example, the phases of reception signals for DF-Indices corresponding to DFreq fd1 in second and third DA sections 209 are denoted as φ₁(fd1) and φ₂(fd1), respectively. In this case, when the phase difference ΔΦ(fd1)=φ₂(fd1)−φ₁(fd1)−2πfd1Tr between φ₁(fd1) and φ₂(fd1) is ΔΦ(fd1)=±n/(N_{sw}Tᵣ)×2πTr=±(2πn/N_{sw}), DFreq aliasing occurs and first determiner 212 determines that DFreq is fd1+n/(N_{sw}Tᵣ). For example, when N_{sw}=3, ΔΦ(fd1)=±(2πn/N_{sw})=±2π/3, ±4π/3, and first determiner 212 determines DFreq in the frequency range±1/(2Tr) based on these phases. On the other hand, when ΔΦ(fd1)=0, no DFreq aliasing occurs, and first determiner 212 determines that DFreq is fd1.

Note that the present disclosure is not limited to the combination of the outputs of second and third demultiplexers 211, and for example, first determiner 212 can perform DFreq aliasing determination based on the outputs of nth and n+1th demultiplexers 211, and may perform DFreq aliasing determination using a plurality of determination results (for example, majority decision). Here, n is any of from 1 to N_{sw}−1.

For example, first angle measurer 213 may perform not only the operation of the above-described embodiment but also angle measurement on the target object using the second reflected wave signal based on the information (for example, R-Index f_{bp}(q) and DDM-signal demultiplexing index information f_{Tx}(q)) inputted from third to N_{sw}th demultiplexers 211.

Note that first angle measurer 213 may perform the angle measurement for each of the outputs of third to N_{sw}th DA sections 209 inputted via third to N_{sw}th demultiplexers 211, or may perform the angle measurement using a result of combination using in-phase addition or power addition.

Since the center frequencies in the BMS configuration resulting from demultiplexing in second to N_{sw}th demultiplexers 211 are the same, second determiner 212 (also referred to as “multi-reception signal determiner”) determines DFreq based on the phase differences between the reception signals of the reflected wave signals. As a result, the DFreq range that can be observed in radar apparatus 1 (receiver 200a) can be enlarged (for example, the frequency range can be increased to ±1/(2Tr)), and the detectable maximum DFreq can also be increased.

The operation of second determiner 212 differs from that of first determiner 212 in that while first determiner 212 determines DFreq based on the phase difference between the reception signals of the second reflected wave signals demultiplexed in second to N_{sw}th demultiplexers 211, second determiner 212 determines DFreq based on the phase difference between the reception signals of the third reflected wave signals demultiplexed in second to N_{sw}th demultiplexers 211. The other operations are the same, and thus detailed explanation thereof is omitted.

The Doppler determination result obtained by enlarging the observable DFreq range in second determiner 212 may be output to, for example, second angle measurer 213 together with the input information from second to N_{sw}th demultiplexers 211.

For example, second angle measurer 213 of qth radar section 10 may perform not only the operations of the above-described embodiment but also angle measurement on the target object using the second-to-N_{sw}th-demultiplexer multi-reception signal outputs based on the information (for example, R-Index f_{bp}(qe) and DDM-signal demultiplexing index information f_{Tx}(qe)) inputted from second to N_{sw}th demultiplexers 211. Note that second angle measurer 213 may perform the angle measurement for each of the outputs of second to N_{sw}th DA sections 209 inputted via second to N_{sw}th demultiplexers 211, or may perform the angle measurement using a result of combination using in-phase addition or power addition.

As described above, in Variation 1, it is possible to obtain, in addition to the effects of the above-described embodiment, an effect of increasing detectable DFreq also with respect to the radar reception signal related to the BMS configuration.

Further, in Variation 1, since it is not necessary to perform DFreq determination in determiner 212 based on a DFreq difference, the FDM transmission can be applied in the BMS configuration with a frequency difference that does not satisfy the condition of center frequency difference Δfc. Therefore, even when the frequency band that can be assigned for radar apparatus 1 is narrow, the same effects as those of the above-described embodiment can be obtained by applying Variation 1.

Further, in Variation 1, as N_{sw} is larger, the time (the number of times of chirp transmission) for simultaneous transmission in the MNS configuration and BMS configuration increases. It is thus possible to shorten the transmission time for obtaining the reception quality (for example, Signal to Noise Ratio (SNR)) of the reflected wave signal. Further, it is possible to improve the reception SNR of the reflected wave signal at a certain transmission period, and thus to expand the detection range in radar apparatus 1.

### (Variation 2)

In Variation 2 as in Variation 1, in a plurality of transmission periods in which TxSig is transmitted, a transmission period in which the same-frequency transmission is performed is continuously set after a transmission period in which the FDM transmission is performed. In Variation 2, the center frequencies of TxSig in the plurality of transmission periods in which the same-frequency transmission is performed differ from one another.

For example, as in Variation 1, controller 304 of synchronizer 20 may configure parameters related to a chirp signal such that the center frequency of the chirp signal is varied at every predetermined transmission period such that the same-frequency transmission is repeated (N_{sw}−1) times after the FDM transmission in the BMS configuration. Further, in Variation 2, the center frequencies of the chirp signals repeatedly transmitted (N_{sw}−1) times may be set to a frequency that coincides with the center frequency of the chirp signal at the time of FDM transmission, alternately or per predetermined transmission periods.

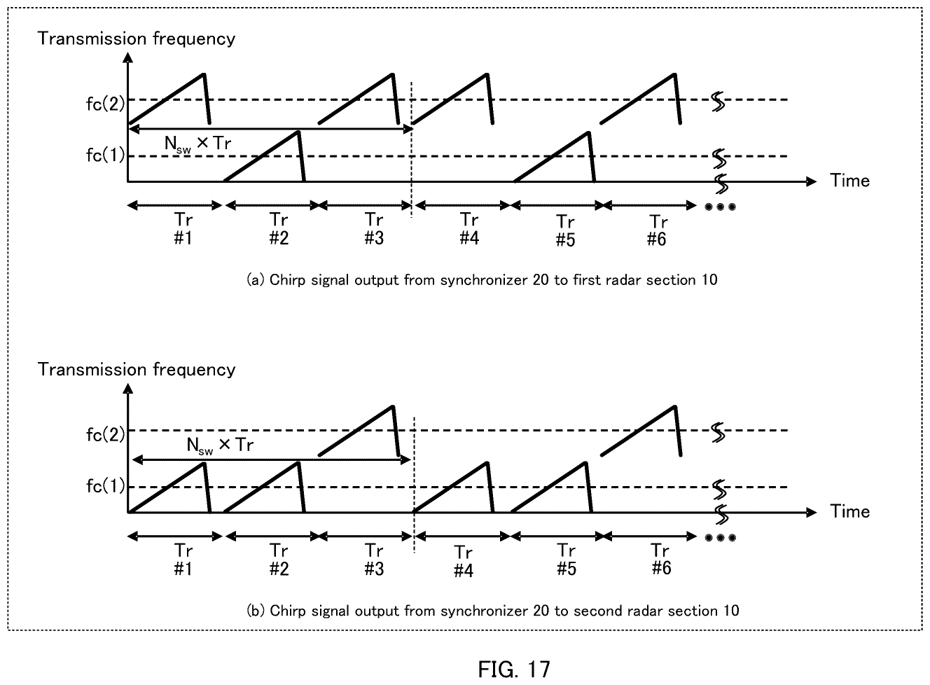

FIG. 17 illustrates an exemplary chirp signal for which a transmission period in which two same-frequency transmissions are performed is configured after a transmission period in which the FDM transmission is performed, in a case where, in the BMS configuration, a transmission cycle at which the FDM transmission and the same-frequency transmission are switched is 3Tr (N_{sw}=3).

For example, within 3Tr of transmission periods Tᵣ #1 to Tᵣ #3 illustrated in FIG. 17, the FDM transmission (for example, center frequencies fc(1) and fc(2)) is performed in transmission period Tᵣ #1, the same-frequency transmission is performed at center frequency fc(1) in transmission period Tᵣ #2, and the same-frequency transmission is performed at center frequency fc(2) at transmission period Tᵣ #3. As described above, the center frequency of TxSig in each of the transmission periods in which the same-frequency transmission is performed (N_{sw}−1) times may be any one of the center frequencies set for FDM of the transmission period in which FDM is performed. The same applies to 3Tr of transmission periods Tᵣ #4 to Tᵣ #6 illustrated in FIG. 17 and the subsequent transmission periods.

As illustrated in FIG. 17, when the same-frequency transmissions are repeated (N_{sw}−1) times, it is possible not only to achieve the advantages of the above-described embodiment but also to increase the detectable DFreq for the radar reception signal between the BMS configurations.

The subsequent operations of transmitter 100 of radar section 10 are the same as those of the above-described embodiment.

Next, an exemplary operation of receiver 200b according to Variation 2 will be described.

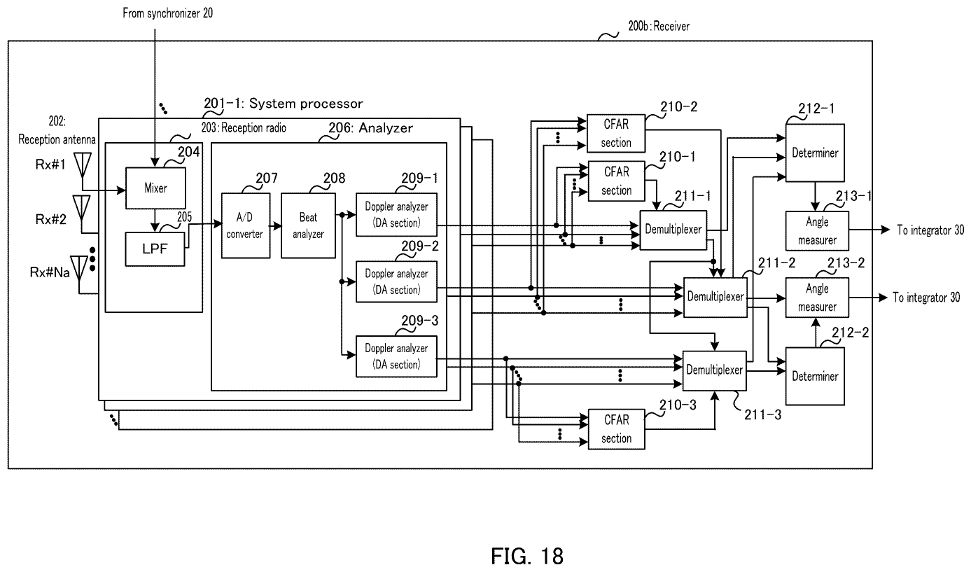

In receiver 200b illustrated in FIG. 18, DA sections 209 of zth analyzer 206 perform the same operation as that of first to N_{sw}th DA sections 209 in Variation 1. Among BF responses RFT_{z}(f_{b}, m) obtained by the mth chirp signal transmission, uth DA section 209 performs Doppler analysis using BF response RFT_{z}(f_{b}, m) providing mod (m−1, N_{sw})=u−1. Here, m=1 to N_{c} and u=1 to N_{sw}. Note that receiver 200b illustrated in FIG. 18 indicates an example in which N_{sw}=3.

Next, an exemplary operation of CFAR sections 210 illustrated in FIG. 18 will be described.

In FIG. 18, for example, first CFAR section 210 performs the same process as first CFAR section 210 of the above-described embodiment.

In addition, in FIG. 18, from among outputs VFT_{1,q}^{Mix(u)}(f_{b}, fₛ), VFT_{2,q}^{Mix(u)}(f_{b}, fₛ, . . . , and VFT_{Na(q),q}^{Mix(u)}(f_{b}, fₛ) (e.g., u=2 to N_{sw}) of the mono- & multi-reception DA sections among DA sections 209 of first to Na(q)th analyzers 206, an output of DA section 209 in a transmission period in which the center frequency of the chirp signal by the same-frequency transmission in the BMS configuration is lower (e.g., the transmission period for fc(1) in FIG. 17) (hereinafter, the output of corresponding CFAR section 209 is referred to as “u_{low}th-DA-section output”) is, for example, input to second DA section 210. For example, second CFAR section 210 selectively extracts a local peak of the third reflected wave signal using a power addition value of reception power values of u_{low}th-DA-section outputs. Note that the local peak extracting process in second CFAR section 210 may be the same process as in the above-described embodiment. For example, second CFAR section 210 may extract R-Index f_{bp}^{MixLo}w and DF-Index f_{sdcp}^{MixLow} extracted by CFAR processing that provide the local peak signal, and output them to u_{low}th demultiplexer 211 (for example, second demultiplexer 211 or demultiplexer 211-2).

From among outputs VFT_{1,q}^{Mix(u)}(f_{b}, fₛ), VFT_{2,q}^{Mix(u)}(f_{b}, fₛ), . . . , and VFT_{Na(q), q}^{Mix(u)}(f_{b}, fₛ) (e.g., u=2 to N_{sw}) of the mono- & multi-reception DA sections among DA sections 209 of first to Na(q)th analyzers 206, an output of DA section 209 in a transmission period in which the center frequency of the chirp signal by the same-frequency transmission in the BMS configuration is higher (e.g., the transmission period for fc(2) in FIG. 17) (hereinafter, the output of corresponding CFAR section 209 is referred to as “uₕᵢth-Doppler-analysis (DA)-section output”) is, for example, input to third DA section 210. For example, third CFAR section 210 selectively extracts a local peak of a reflected wave signal in the BMS configuration (e.g., fourth reflected wave signal) using a power addition value of reception power values of uₕᵢth-DA-section outputs. Note that the local peak extracting process in third CFAR section 210 may be the same process as in the above-described embodiment. For example, third CFAR section 210 may extract R-Index f_{bp}^{MixHi} and DF-Index f_{sdcp}^{MixHi} extracted by CFAR processing that provide the local peak signal, and output them to uₕᵢth demultiplexer 211 (for example, third demultiplexer 211 or demultiplexer 211-3).

Among second to N_{sw}th demultiplexers 211 (or demultiplexers 211-2 to 211-N_{sw}), demultiplexer 211 (hereinafter, referred to as u_{low}th demultiplexer 211; in FIG. 18, second demultiplexer 211) to which the u_{low}th-DA-section output is input performs a demultiplexing operation based on the output of second CFAR section 210. In addition, among second to N_{sw}th demultiplexers 211, demultiplexer 211 (hereinafter, referred to as uₕᵢth demultiplexer 211; in FIG. 18, third demultiplexer 211) to which the uₕᵢth-DA-section output is input performs a demultiplexing operation based on the output of third CFAR section 210. The other operations performed by demultiplexers 211 are the same as those performed by demultiplexers 211 in Variation 1, and thus description of the operations is omitted.

First determiner 212 may perform the same operation as determiner 212 of the above-described embodiment. Further, first determiner 212 may determine DFreq by combining the following operations or the operations of the above-described embodiment. The DFreq determination accuracy can be improved by using a plurality of combinations. The Doppler determination result obtained by enlarging the observable DFreq range of first determiner 212 may be output to first angle measurer 213, for example, together with the input information from first to N_{sw}th demultiplexers 211.

The reflected wave signals in the MNS configuration that are demultiplexed in second to N_{sw}th demultiplexers 211 include a component having the same center frequency as the first reflected wave signal demultiplexed in first demultiplexer 211. Accordingly, first determiner 212 determines DFreq based on the phase differences between the reception signals of the reflected wave signals, using either the outputs of u_{low}th demultiplexer 211 or the outputs of uₕᵢth demultiplexer 211. As a result, the DFreq range that can be observed in radar apparatus 1 (receiver 200b) can be enlarged (for example, the frequency range can be increased to ±1/(2Tr)), and the detectable maximum DFreq can also be increased.

TxSig s demultiplexed in second to N_{sw}th demultiplexers 211 and coinciding with the center frequency of the chirp signal at the time of FDM transmission in qeth radar section 10 in the BMS configuration is transmitted alternately or per predetermined transmission periods. Therefore, like the operation of first determiner 212, second determiner 212 (also referred to as a multi-reception signal determiner) determines DFreq based on the phase difference between the reception signals of the reflected wave signals (for example, the case where transmission condition 1 is satisfied) or DFreq difference (for example, the case where transmission condition 2 is satisfied). As a result, DFreq range that can be observed in radar apparatus 1 (receiver 200b) can be enlarged (for example, the frequency range can be increased to ±1/(2Tr)), and the detectable maximum DFreq can also be increased. The Doppler determination result obtained by enlarging the observable DFreq range of second determiner 212 may be output to, for example, second angle measurer 213 together with the input information from second to N_{sw}th demultiplexers 211.

Second determiner 212 determines DFreq based on the frequency difference between the reflected wave signals in the BMS configurations that are demultiplexed by second to N_{sw}th demultiplexers 211. Since this operation is the same as the operation of determiner 212 of the above-described embodiment, a detailed description thereof will be omitted. The Doppler determination result obtained by enlarging the observable DFreq range in second determiner 212 may be output to, for example, second angle measurer 213 together with the input information from second to N_{sw}th demultiplexers 211.

The operations of first and second angle measurers 213 illustrated in FIG. 18 are the same as those of Variation 1, and the description of the operations is omitted.

As described above, in Variation 2, it is possible to obtain, in addition to the effects of the embodiment, an effect of increasing detectable DFreq also with respect to the radar reception signal related to the BMS configuration.

Further, in Variation 2, when a chirp signal whose center frequency at the time of the same-frequency transmission is identical to the center frequency at the time of FDM transmission is included, it is not necessary to perform DFreq determination in first determiner 212 based on a DFreq difference. Thus, the FDM transmission can be applied in the BMS configuration with a frequency difference that does not satisfy the condition of center frequency difference Δfc. Therefore, even when the frequency band that can be assigned for radar apparatus 1 is narrow, the same effects as those of the above-described embodiment can be obtained by applying Variation 2.

Further, in Variation 2, as N_{sw} is larger, the time (the number of times of chirp transmission) for simultaneous transmission in the MNS configuration and BMS configuration increases. It is thus possible to shorten the transmission time for obtaining the reception quality (SNR) of the reflected wave signal. Further, it is possible to improve the reception SNR of the reflected wave signal at a certain transmission period, and thus to expand the detection range in radar apparatus 1.

### (Variation 3)

In Variation 3, a plurality of transmission periods in which the FDM transmission is performed are configured continuously in a plurality of transmission periods in which TxSig is transmitted. A transmission period in which at least one same-frequency transmission is performed is configured after a plurality of transmission periods in which FDM is performed. In Variation 3, for example, the center frequencies of respective TxSig in a plurality of transmission periods in which FDM transmissions are performed differ from one another in each of first radar section 10 and second radar section 10.

For example, controller 304 of synchronizer 20 may configure parameters related to the chirp signal such that the center frequency of the chirp signal by the FDM transmission in the BMS configuration is set to be variable alternately or per predetermined transmission periods, and α times of FDM transmissions are repeated. Further, controller 304 may configure the parameters related to the chirp signal such that the center frequency of the chirp signal is variable per predetermined transmission periods such that the same-frequency transmission is repeated (N_{sw}−α) times after a times of FDM transmission.

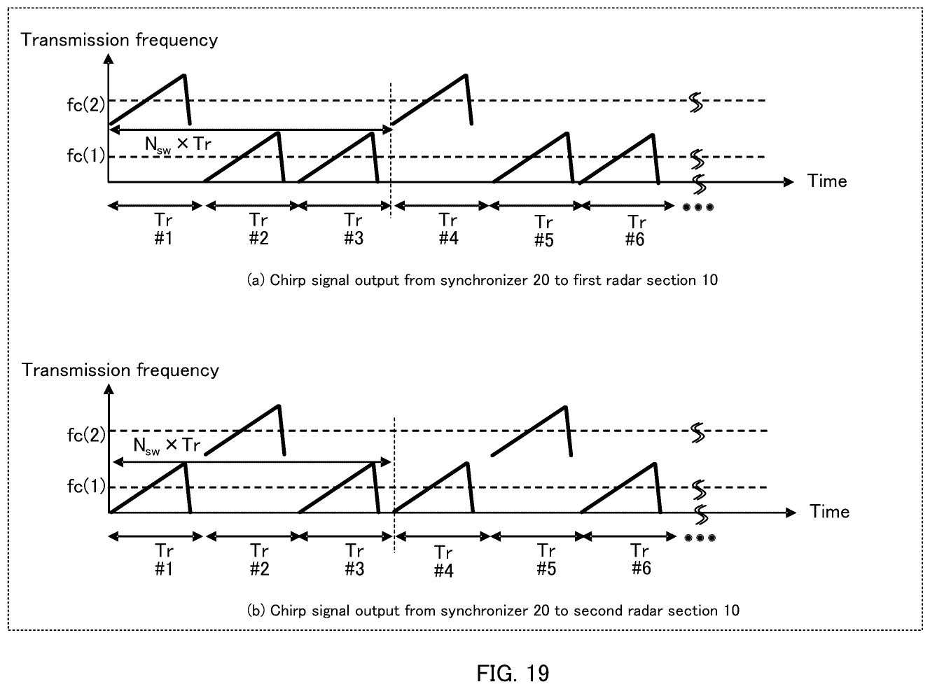

FIG. 19 illustrates an exemplary chirp signal in the BMS configuration in which the same-frequency transmission is performed once after α (=2) times of FDM transmission when transmission periods for switching between the FDM transmission and the same-frequency transmission is 3Tr (N_{sw}=3).

For example, among 3Tr of transmission periods Tᵣ #1 to Tᵣ #3 illustrated in FIG. 19, the FDM transmission is performed in transmission period Tᵣ #1, the FDM transmission is performed in transmission period Tᵣ #2 while the center frequencies of chirp signals in transmission period Tᵣ #1 are switched between first radar section 10 and second radar section 10, and the same-frequency transmission is performed in transmission period Tᵣ #3. As described above, the center frequency of TxSig in each of the transmission periods in which the FDM transmission is performed α times may be switched between first radar section 10 and the second radar section. The same applies to 3Tr of transmission periods Tᵣ #4 to Tᵣ #6 illustrated in FIG. 19 and the subsequent transmission periods.

As illustrated in FIG. 19, when the center frequency of the chirp signal transmitted by the FDM transmission is set to be variable alternately for each transmission period, the center frequency of the chirp signal of either first radar section 10 or second radar section 10 may coincide with the center frequency of the chirp signal transmitted by the same-frequency transmission in the BMS configuration (for example, in FIG. 19, fc(1)) (hereinafter, referred to as “transmission condition 3”). When transmission condition 3 is satisfied, not only that the advantages of the above-described embodiment are obtained, but also that the determination of DFreq based on DFreq differences in determiner 212 does not have to be performed. Thus, in the BMS configuration, the FDM transmissions may be applied with a frequency difference that does not satisfy the condition of center frequency difference Δfd, and therefore, even when the frequency band assignable for radar apparatus 1 is narrow, the same advantages as in the embodiment can be obtained by applying Variation 3.

The subsequent operations of transmitter 100 of radar section 10 are the same as those of the above-described embodiment.

Next, an exemplary operation of receiver 200c according to Variation 3 will be described.

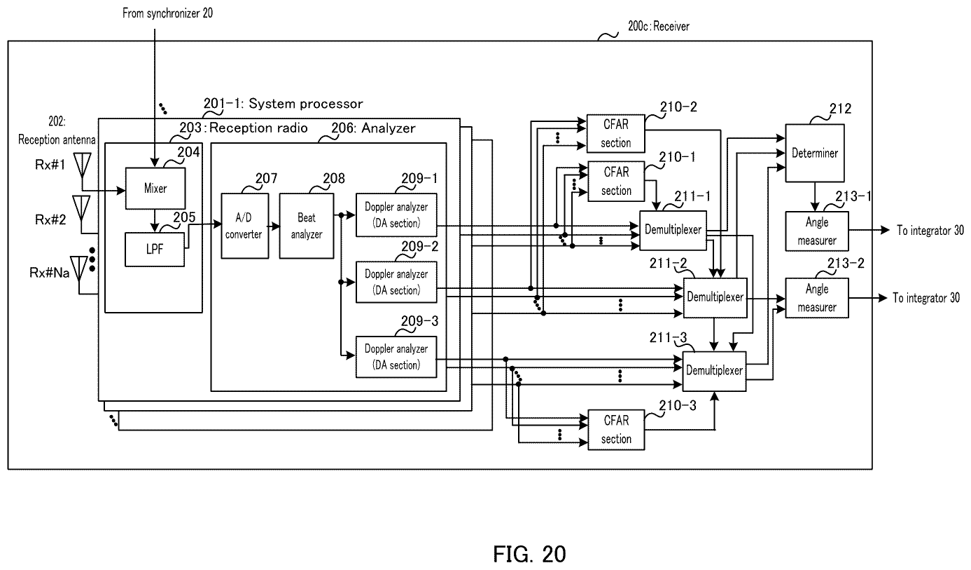

In receiver 200c illustrated in FIG. 20, DA sections 209 of zth analyzer 206 perform the same operation as that of first to N_{sw}th DA sections 209 in Variation 1. Among BF responses RFT_{z}(f_{b}, m) obtained by the mth chirp signal transmission, uth DA section 209 performs Doppler analysis using BF response RFT_{z}(f_{b}, m) providing mod (m−1, N_{sw})=u−1. Here, m=1 to Ne and u=1 to N_{sw}. Note that receiver 200c illustrated in FIG. 20 indicates an example in which N_{sw}=3.

Of N_{sw} DA sections 209, an output of DA section 209 (mono-reception DA section) for a reception signal transmitted by the FDM transmission in the BMS configuration is denoted as VFT_{z,q}^{Mono(v1)}(f_{b}, fₛ) (for example, z=1 to Na(q)). Here, “v1” represents an ordinal number of a transmission period of N_{sw} transmission periods in which the FDM transmission is performed in the BMS configuration. For example, in the case of FIG. 19, since the FDM transmission and the same-frequency transmission are switched in N_{sw} (=3) transmission periods and the FDM transmission is performed in the first and second transmission periods of N_{sw} (=3) transmission periods, v1th DA sections 209 (v1=1, 2) correspond to the mono-reception DA section.

Further, an output of DA section 209 (mono- & multi-reception DA section) of N_{sw} DA sections 209 in response to a reception signal of the same-frequency transmission in the BMS configuration is referred to as a VFT_{z,q}^{Mix(v2)}(f_{b}, fₛ). Here, z=1 to Na(q), and “v2” represents an ordinal number of a transmission period of N_{sw} transmission periods in which the same-frequency transmission is performed in the BMS configuration. For example, in the case of FIG. 19, since the same-frequency transmission is performed in the third transmission period of N_{sw} (=3) transmission periods, v2th DA section 209 (v2=3) corresponds to the mono- & multi-reception DA section.

Next, an exemplary operation of CFAR section 210 illustrated in FIG. 20 will be described.

In FIG. 20, from among outputs VFT_{z,q}^{Mono(v1)}(f_{b}, fₛ) (e.g., z=1 to Na(q)) of the mono-reception DA sections of first to Na(q)th analyzers 206, an output of DA section 209 in a transmission period in which the center frequency of the chirp signal by the FDM transmission in the BMS configuration is lower (e.g., the transmission period for fc(1) in FIG. 19) (hereinafter, referred to as “v1_{low}th-Doppler-analysis (DA)-section output”) is, for example, input to first DA section 210. For example, first CFAR section 210 selectively extracts a local peak of a reflected wave signal in the MNS configuration using a power addition value of reception power values of v1_{low}th-DA-section outputs. Note that the local peak extracting process in first CFAR section 210 may be the same process as in the above-described embodiment. For example, first CFAR section 210 may extract R-Index f_{bp}^{MonoLow} and DF-Index f_{sdcp}^{MonoLow} extracted by CFAR processing that provide the local peak signal, and output them to v1_{low}th demultiplexer 211 (for example, first demultiplexer 211).

From among outputs VFT_{z,q}^{Mono(v1)}(f_{b}, fₛ) (e.g., z=1 to Na(q)) of the mono-reception DA sections of first to Na(q)th analyzers 206, an output of DA section 209 in a transmission period in which the center frequency of the chirp signal by the FDM transmission in the BMS configuration is higher (e.g., the transmission period for fc(1) in FIG. 19) (hereinafter, referred to as “v1ₕᵢth-Doppler-analysis (DA)-section output”) is, for example, input to second DA section 210. For example, second CFAR section 210 selectively extracts a local peak of a reflected wave signal in the MNS configuration using a power addition value of reception power values of v1ₕᵢth-DA-section outputs. Note that the local peak-extracting process in second CFAR section 210 may be the same process as in the above-described embodiment. For example, second CFAR section 210 may extract R-Index f_{bp}^{Monohi} and DF-Index f_{sdcp}^{Monohi} extracted by CFAR processing that provide the local peak signal, and output them to v1ₕᵢth demultiplexer 211 (for example, second demultiplexer 211).

Outputs VFT_{z,q}^{Mix(v2)}(f_{b}, fₛ) (for example, z=1 to Na(q)) of the mono- & multi-reception DA section among first to Na(q)th analyzers 206 are input to third CFAR section 210. For example, third CFAR section 210 selectively extracts a local peak of a reflected wave signal in the BMS configuration by using the power addition values of reception power values of outputs of the mono- & multi-reception DA sections. Note that the local peak-extracting process in third CFAR section 210 may be the same process as in the above-described embodiment. For example, third CFAR section 210 may extract R-Index fop Mix and DF-Index f_{sdcp}^{Mix} extracted by CFAR processing that provide the local peak signal, and output them to v2th demultiplexer 211 (for example, second demultiplexer 211).

The v1_{low}th demultiplexer 211 is a demultiplexer to which the v1_{low}th-DA-section output is input, and performs demultiplexing based on the output of first CFAR section 210.

The v1ₕᵢth demultiplexer 211 is a demultiplexer to which the v1ₕᵢth-DA-section output is input, and performs demultiplexing based on the output of second CFAR section 210.

The v2th demultiplexer is a demultiplexer to which the output of the mono- & multi-reception DA section is input, and may perform a demultiplexing operation based on the output of third CFAR section 210, the output of v1_{low}th demultiplexer 211, and the output of v1ₕᵢth demultiplexer 211, or may perform a demultiplexing operation based on the output of demultiplexer 211 providing the center frequency of the chirp signal by the same-frequency transmission the same as the center frequency of the chirp signal by the FDM transmission in the BMS configuration, among the outputs of v1_{low}th demultiplexer 211 and v1ₕᵢth demultiplexer 211.

Note that the demultiplexing operations performed by v1_{low}th demultiplexer 211, v1ₕᵢth demultiplexer 211, and v2th demultiplexer 211 are the same as those performed by demultiplexer 211 in the above-described embodiment, and therefore, the description of the operations is omitted.

Further, v1_{low}th demultiplexer 211 and v1ₕᵢth demultiplexer 211 output, for example, information obtained by demultiplexing the reflected wave signal in the MNS configuration (also referred to as “demultiplexer mono-reception-signal output” for example) to determiner 212.

Similarly to second demultiplexer 211 in the above-described embodiment, v2th demultiplexer 211 outputs, to determiner 212, information obtained by demultiplexing the reflected wave signal in the MNS configuration (for example, also referred to as “v2th-demultiplexer mono-reception-signal output”), for example. Further, v2th demultiplexer 211 outputs, to second angle measurer 213, information obtained by demultiplexing the reflected wave signal in the BMS configuration (for example, also referred to as “v2th-demultiplexer multi-reception-signal output”).

In Variation 3, since transmission condition 3 is satisfied, determiner 212 can perform the following operations.

For example, for at least one of v1_{low}th demultiplexer 211 and v1ₕᵢth demultiplexer 211 in the BMS configuration and FDM transmission, determiner 212 determines DFreq based on a phase difference (for example, transmission condition 1) from the reflected wave signal in the MNS configuration demultiplexed in v2th demultiplexer 211 in the BMS configuration and the same-frequency transmission.

As a result, the DFreq range that can be observed in the radar apparatus (receiver 200c) can be enlarged (for example, the frequency range can be increased to ±1/(2Tr)), and the detectable maximum DFreq can also be increased. Note that the Doppler determination result obtained by enlarging the DFreq range observable by determiner 212 together with the input information from v1_{low}th, v1ₕᵢth, and v2th demultiplexers 211 may be output, for example, to first angle measurer 213.

For example, first angle measurer 213 of qth radar section 10 performs not only the operations of the above-described embodiment but also angle measurement on the target object using the reflected wave signal in the MNS configuration based on the information (for example, R-Index f_{bp}(q) and DDM-signal demultiplexing index information f_{Tx}(q)) inputted from v1_{low}th, v1ₕᵢth, and v2th demultiplexers 211. Note that the angle measurement may be performed for each of the outputs of v1_{low}th, v1ₕᵢth, and v2th DA sections 209 inputted via v1_{low}th, v1ₕᵢth, and v2th demultiplexers 211, or may be performed the angle measurement using a result of combination using in-phase addition or power addition.

As described above, in Variation 3, not only that the advantages of the above-described embodiment are obtained, but also that the inter-BMS FDM transmission can be applied with a frequency difference that does not satisfy the condition of center frequency difference Δfc since it is not necessary to perform DFreq determination in determiner 212 based on a DFreq difference. Therefore, even when the frequency band that can be assigned for radar apparatus 1 is narrow, the same effects as those of the above-described embodiment can be obtained by applying Variation 3.

Note that, determiner 212 may determine DFreq by combining DFreq determination based on a phase difference (for example, transmission condition 1) of the reflected wave signal and DFreq determination based on a DFreq difference (for example, transmission condition 2) between the reflected wave signals. In this case, not only that the advantages of the embodiment are obtained, but also that the determination accuracy of determiner 212 when SNR of the reception signal of the reflected wave signal is lower can be enhanced.

Further, for example, transmission in which Variation 3 and Variation 1 or 2 are combined together is also possible, and effects of the combined variations can be obtained.

### (Variation 4)

As illustrated in FIG. 4, the above-described embodiment has been described with respect to the case where first radar section 10 and second radar section 10 transmit chirp signals having center frequencies differing by Δfd from each other in the FDM transmission in the BMS configuration, but the method of FDM transmission is not limited to this. For the FDM transmission, it is also possible, for example, to achieve different transmission timings for chirp signals having the same center frequency between first radar section 10 and second radar section 10.

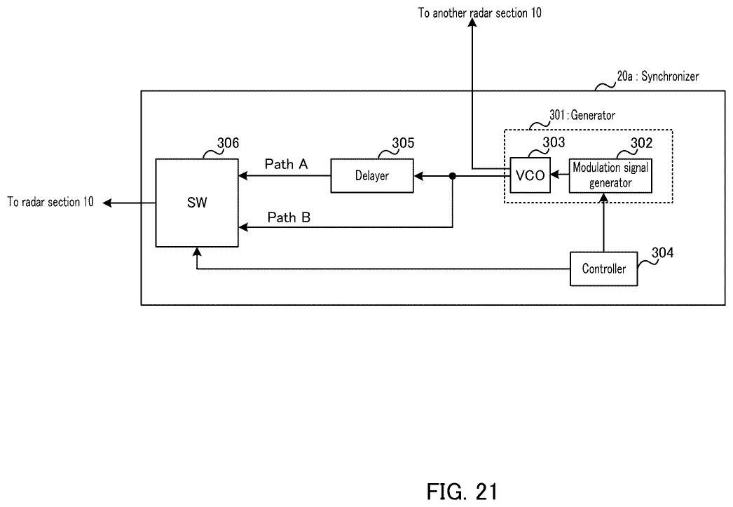

FIG. 21 illustrates an exemplary configuration of synchronizer 20a of radar apparatus 1 according to Variation 4. As illustrated in FIG. 21, synchronizer 20a includes generator 301, controller 304, delayer 305, and switch (SW) 306. Note that the configuration of radar section 10 may be any one of the configurations of the above-described embodiment and Variations 1 to 3.

Synchronizer 20a illustrated in FIG. 21 realizes the FDM transmission by switching between transmission delay ON and transmission delay OFF for each transmission period using delayer 305, for example.

For example, in the case of the transmission delay ON, controller 304 controls SW 306 such that a signal (path A) that has passed through delayer 305 for delaying in time an output of VCO 303 is output to radar section 10. On the other hand, in the case of the transmission delay OFF, controller 304 controls SW 306 such that a signal (path B) that does not pass through delayer 305 for delaying in time the output of VCO 303 is output to radar section 10.

Thus, in the case of the transmission delay ON, radar section 10 transmits TxSig at a timing with a delay later than another radar section 10, and in the case of the transmission delay OFF, radar section 10 transmits TxSig at the same timing as the other radar section 10.

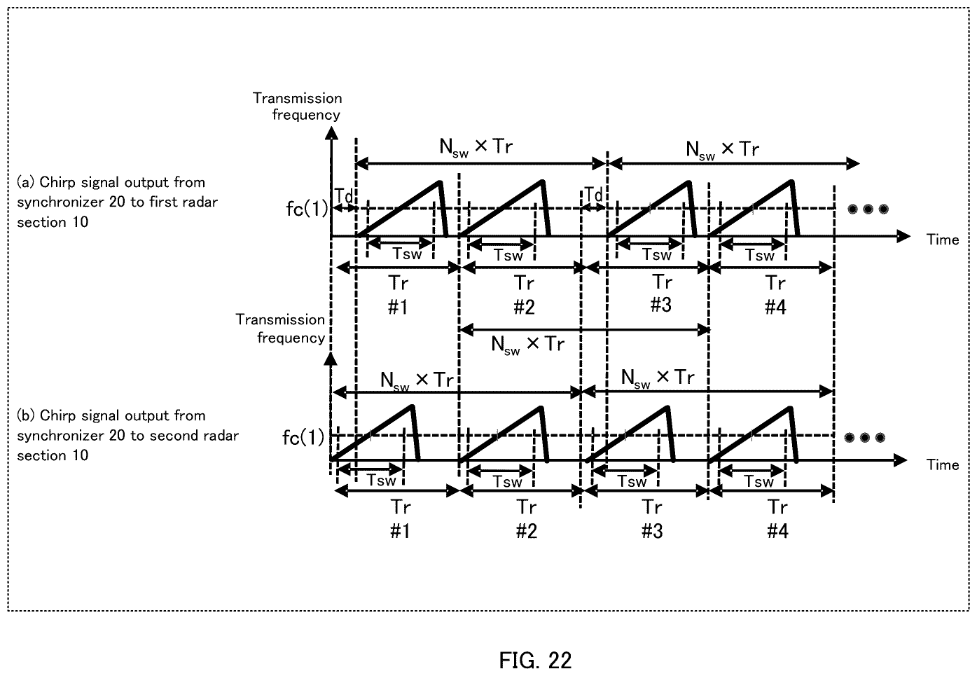

FIG. 22 illustrates an example of transmission of a chirp signal according to Variation 4.

As illustrated in FIG. 22, in certain transmission periods (e.g., Tᵣ #1 and Tᵣ #3), the transmission timings of chirp signals having center frequency fc(1) differ from each other by Td between first radar section 10 and second radar section 10 (e.g., the transmission timing of first radar section 10 at (a) in FIG. 22 is delayed relative to the transmission timing of second radar section 10 at (b) in FIG. 22). This produces an effect equivalent to that in a case where center frequency difference Δfd is set to Dm×Td because a frequency difference of Dm×Td occurs at the same time between the transmission frequency of the chirp signal of qth radar section 10 and the transmission frequency of the chirp signal of qeth radar section 10. Here, Dₘ is the rate of change in frequency sweep of the chirp signal.

Td may be adjusted so that a reflected wave signal in the BMS configuration is out of a frequency pass band of LPF 205 when the output of mixer 204 is caused to pass LPF 205, in order to block the reflected wave signal in the BMS configuration. The FDM transmission thus becomes possible. For example, when the expected maximum distance for the target object is Rmax, the reflected wave signal is received with a time difference of minimum Td−2Rmax/C₀. Therefore, Td may be set to satisfy Dm×(Td−2Rmax/C₀)>f_{LPF_cutoff}) with respect to cutoff frequency f_{cutoff} of LPF 205. As a result, the reflected wave signal in the BMS configuration is out of the frequency pass band of LPF 205 and the FDM transmission becomes possible.

In addition, correspondingly to the transmission timings of the chirp signals having center frequency fc(1) being made different (shifted) from each other by Td between first radar section 10 and second radar section 10, range gate T_{sw} at the time of transmission of the chirp signal of FDM transmission may be different by Td from the timing of range gate T_{sw} at the time of transmission of the chirp signal of the same-frequency transmission. Thus, in radar apparatus 1, a reception signal in a case where the center frequency of the chirp signal is the same between when the FDM transmission of the chirp signal is performed and when the same-frequency transmission of the chirp signal is performed is obtained.

In Variation 4, since the chirp signals with the same center frequency are transmitted, the determination of transmission condition 1 that is based on the phase difference can be made in the DFreq aliasing determination operation in determiner 212. Therefore, even when center frequency difference Δfd=Dm×Td does not satisfy the frequency condition in the above-described embodiment, the advantage of increasing a detectable DFreq can be obtained as in the above-described embodiment.

As described above, in Variation 4, not only that the effects of the above-described embodiment can be obtained, but also that it is not necessary to perform DFreq determination based on DFreq differences in determiner 212, and thus, even when the frequency band assignable for radar apparatus 1 is narrow, the same effects as those of the above-described embodiment can be obtained by applying Variation 4.

Note that the FDM transmission in the BMS configuration can be realized by using delayer 305 that applies a transmission delay in synchronizer 20a, and therefore, for example, radar apparatus 1 does not need to include a plurality of VCO 303 or a VCO frequency converter for performing frequency conversion on outputs of VCO 303. It is thus possible to further simplify the circuit configuration of radar apparatus 1.

Further, Variation 4 is applicable not only to the above-described embodiment, but also to any of Variations 1 to 3. For example, radar apparatus 1 transmits chirp signals having the same center frequency at different transmission timings in first radar section 10 and second radar section 10, instead of the inter-BMS FDM transmission in Variations 1 to 3. As a result, the effects described in Variation 4 are also obtained in addition to the effects of Variations 1 to 3.

### (Variation 5)

As illustrated in FIG. 4, the above-described embodiment has been described with respect to the operation in which chirp signals are transmitted at the same timing in first radar section 10 and second radar section 10 in the same-frequency transmission in the BMS configuration, but the same-frequency transmission is not limited thereto. For example, the same-frequency transmission can produce the same effect also when the same chirp signal is transmitted at transmission timings of the chirp signal that differ (or are shifted) from each other between first radar section 10 and second radar section 10.

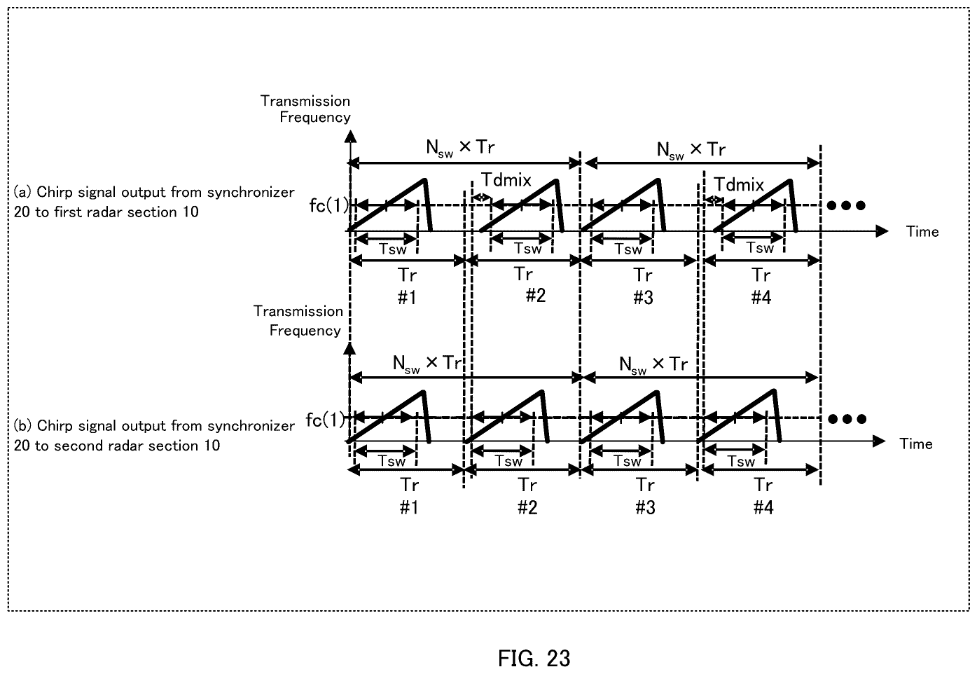

FIG. 23 illustrates an example of transmission of a chirp signal according to Variation 5.

As illustrated in FIG. 23, in certain transmission periods (for example, Tᵣ #2 and Tᵣ #4), the transmission timings of chirp signals having center frequency fc(1) differ from each other by Tdmix between first radar section 10 at (a) in FIG. 23 and second radar section 10 at (b) in FIG. 23 (for example, the transmission timing of first radar section 10 is delayed). Note that the same operation (for example, the operation by synchronizer 20a illustrated in FIG. 21) as the operation in the configuration for the transmission timings of the chirp signals at the time of the FDM transmission in Variation 4 may be applied to the configuration for the transmission timings of the chirp signals at the time of the same-frequency transmission (for example, a configuration for a delay).

For example, Tdmix may be adjusted such that when the output of mixer 204 passes LPF 205, the reflected wave signal in the BMS configuration may be received (or passed) and may be within the frequency pass band of LPF 205. For example, when the expected maximum distance for the target object is Rmax, the reflected wave signal is received with a time difference of maximum Tdmix+2Rmax/C₀. Therefore, Tdmix may be set to satisfy Dm×(Tdmix+2Rmax/C₀)<f_{LPF_cutoff} with respect to cutoff frequency f_{cutoff} of LPF 205. It is thus possible to also receive the reflected wave signal in the BMS configuration. Further, by setting such Tdmix, a reception time for a reflected wave signal in the BMS configuration can be relatively shifted from a reception time for a reflected wave signal of TxSig from own radar in the BMS configuration.

For example, when a reflected wave signal within a short range arrives densely in both own radar and another radar, radar apparatus 1 configures Tdmix to shift reception times relatively, so that demultiplexing of mono/multi-signals in second demultiplexer 211 in the above-described embodiment can be facilitated. Note that Variation 5 is applicable not only to the above-described embodiment, but also to any of Variations 1 to 4 to obtain the same effects.

### (Variation 6)

The above embodiment has been described with respect to the BMS configuration of first radar section 10 and second radar section 10, but the present disclosure is not limited thereto. For example, two or more radar sections 10 may be used in the BMS configuration, and the same advantages as those of the above-described embodiment can be obtained. For example, two or more radar sections 10 may be used similarly for Variations 1 to 5, and effects similar to those of the respective variations can be obtained.

For example, when three radar sections 10 are used and applied to the above-described embodiment, the following operation is performed.

In the inter-BMS radar configuration, controller 304 configures the modulation parameters of the chirp signal such that the FDM transmission and the same-frequency transmission are alternately switched for each transmission period Tr.

In this case, three radar sections 10 transmit chirp signals having center frequencies that differ from each other by Δfd or more greatly in the FDM transmission in the BMS configuration. In addition, in the same-frequency transmission in the BMS configuration, the same chirp signal is transmitted by three radar sections 10. In this case, two other radar sections 10 different from each radar section 10 are included. For this reason, for example, DDM signals applied in DS sections 101 of radar sections 10 may be different from one another. For example, multiplexed signals are applied such that the numbers of DDM and DDM intervals for radar sections 10 are different from one another, whereby even when a plurality of other radar sections 10 different from each radar section 10 are included, demultiplexer 211 can distinguishingly receive the reflected wave signal of TxSig from each radar section 10.

Further, for example, when three radar sections 10 are applied in Variation 4, controller 304 configures the modulation parameters of the chirp signal such that the FDM transmission in the BMS configuration and the same-frequency transmission are alternately switched for each transmission period Tr. In this case, three radar sections 10 transmit chirp signals having center frequencies that differ from each other by Δfd or more greatly in the FDM transmission in the BMS configuration. In addition, in the same-frequency transmission in the inter-BMS radar configuration, the same chirp signal is transmitted by three radar sections 10.

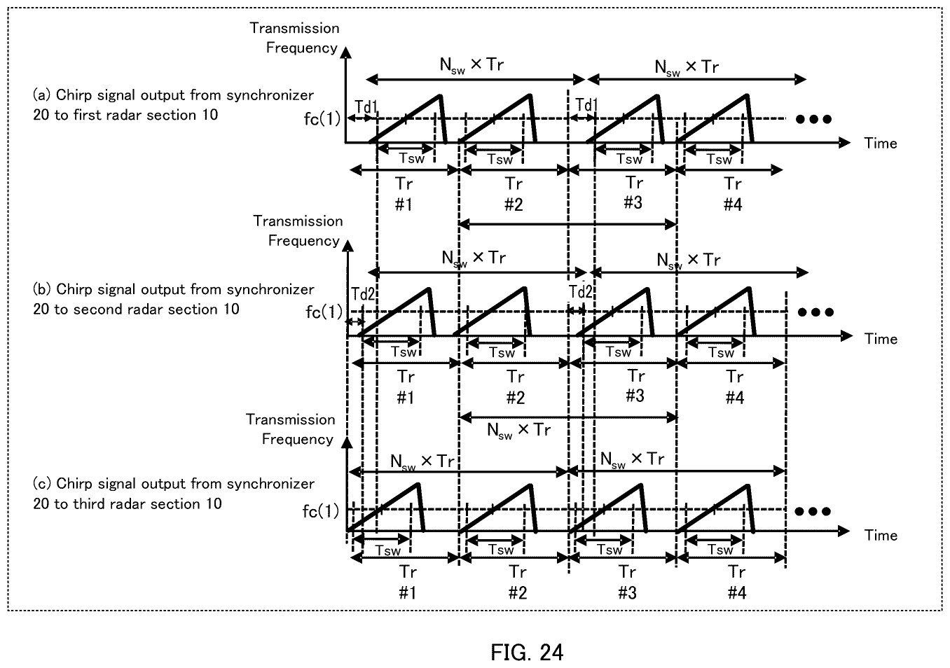

Further, as illustrated in FIG. 24, the transmission timings of chirp signals having center frequency fc(1) is made different (shifted) by Td1 or Td2 between first radar section 10, second radar section 10, and third radar section 10. This produces an effect equivalent to that in a case where center frequency difference Δfd is made different because a frequency difference of any of ±Dm×Td1, ±Dm×Td2, and ±Dm×(Td1−Td2) occurs at the same time between the transmission frequency of the chirp signal of qth radar section 10 and the transmission frequency of the chirp signal of qeth radar section 10.

At this time, Td1 or Td2 may be adjusted such that when the output of mixer 204 in reception radio 203 passes LPF 205, the reflected wave signal in the BMS configuration is outside the frequency pass band of LPF 205 such that the reflected wave signal in the BMS configuration is blocked. The FDM transmission thus becomes possible.

Note in this case that, since two other radar sections 10 differing from each radar section 10 are included, DDM signals applied in DS sections 101 of radar sections 10 may be different from one another, for example. For example, multiplexed signals are applied such that the numbers of DDM and DDM intervals for radar sections 10 are different from one another, whereby even when a plurality of other radar sections 10 different from each radar section 10 are included, demultiplexer 211 can distinguishingly receive the reflected wave signal of TxSig of each radar section 10.

One exemplary embodiment of the present disclosure has been described above.

### OTHER EMBODIMENTS

Regarding the above-described embodiments, the configuration has been described in which the chirp signals are used as TxSig, but TxSig may be signals differing from the chirp signals. For example, the TxSig may be a pulse compression wave, such as a coded pulse signal. When the coded pulse signal is used for TxSig, mixer 204 of reception radio 203 converts a high-frequency reception signal into a baseband signal, and a correlator (not illustrated) that correlates the high-frequency reception signal with the coded pulse signal transmitted is used instead of beat analyzer 208. Accordingly, the subsequent processing can be performed in the same manner as the processing according to each of the above-described embodiments, and the same effects can be obtained.

In the radar apparatus according to one exemplary embodiment of the present disclosure, the transmitter and the receiver may be individually arranged in physically separate locations from each other. In the receiver according to one exemplary embodiment of the present disclosure, the angle measurer and any other component may be individually arranged in physically separate locations.

Further, in one exemplary embodiment of the present disclosure, the numerical values used for parameters such as the number of transmission antennas, the number of reception antennas, the number of DDM, the number of radar sections, the DDM interval, the parameter related to the DDM interval (for example, δ_{q}), and the parameters (e.g., N_{sw}) related to the transmission period are examples, and are not limited to these values.

A radar apparatus according to an exemplary embodiment of the present disclosure includes, for example, a central processing unit (CPU), a storage medium such as a read only memory (ROM) that stores a control program, and a work memory such as a random access memory (RAM), which are not illustrated. In this case, the functions of the sections described above are implemented by the CPU executing the control program. However, the hardware configuration of the radar apparatus is not limited to that in this example. For example, the functional sections of the radar apparatus may be implemented as an integrated circuit (IC). Each functional section may be formed as an individual chip, or some or all of them may be formed into a single chip.

Various embodiments have been described with reference to the drawings hereinabove. Obviously, the present disclosure is not limited to these examples. Obviously, a person skilled in the art would arrive variations and modification examples within a scope described in claims, and it is understood that these variations and modifications are within the technical scope of the present disclosure. Each constituent element of the above-mentioned embodiments may be combined optionally without departing from the spirit of the disclosure.

The expression “section” used in the above-described embodiments may be replaced with another expression such as “circuit (circuitry),” “device,” “unit,” or “module.”

The above embodiments have been described with an example of a configuration using hardware, but the present disclosure can be realized by software in cooperation with hardware.

Each functional block used in the description of each embodiment described above is typically realized by an LSI, which is an integrated circuit. The integrated circuit controls each functional block used in the description of the above embodiments and may include an input terminal and an output terminal. The LSI may be individually formed as chips, or one chip may be formed so as to include a part or all of the functional blocks. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit or a general-purpose processor and a memory. In addition, a Field Programmable Gate Array (FPGA) that can be programmed after the manufacture of the LSI or a reconfigurable processor in which the connections and the settings of circuit cells disposed inside the LSI can be reconfigured may be used.

If future integrated circuit technology replaces LSIs as a result of the advancement of semiconductor technology or other derivative technology, the functional blocks could be integrated using the future integrated circuit technology. Biotechnology can also be applied.

### SUMMARY OF PRESENT DISCLOSURE

A radar apparatus according to one non-limiting and exemplary embodiment of the present disclosure includes: first radar circuitry, which, in operation, transmits a first transmission signal; and second radar circuitry, which, in operation, transmits a second transmission signal; in which a plurality of transmission periods in which the first transmission signal and the second transmission signal are transmitted include a first transmission period in which frequency-division multiplexing transmission of the first transmission signal and the second transmission signal is performed, and a second transmission period in which the first transmission signal and the second transmission signal are transmitted at a same frequency.

In one non-limiting and exemplary embodiment of the present disclosure, the first transmission period and the second transmission period are alternately configured in the plurality of transmission periods.

In one non-limiting and exemplary embodiment of the present disclosure, a plurality of the second transmission periods consecutive to each other are configured after the first transmission period in the plurality of transmission periods.

In one non-limiting and exemplary embodiment of the present disclosure, a center frequency of a transmission signal in each of the plurality of second transmission periods is different.

In one non-limiting and exemplary embodiment of the present disclosure, the center frequency of the transmission signal in each of the plurality of second transmission periods is identical to any of center frequencies set for the frequency-division multiplexing transmission in the first transmission period.

In one non-limiting and exemplary embodiment of the present disclosure, a plurality of the first transmission periods consecutive to each other are configured in the plurality of transmission periods, at least one of the second transmission periods is configured after the plurality of first transmission periods, and a center frequency of a transmission signal of each of the plurality of first transmission periods is different for each of the first radar circuitry and the second radar circuitry.

In one non-limiting and exemplary embodiment of the present disclosure, a center frequency of a transmission signal in at least one transmission period of the plurality of first transmission periods is identical to a center frequency of a transmission signal in the second transmission period for at least one of the first radar circuitry and the second radar circuitry.

In one non-limiting and exemplary embodiment of the present disclosure, a transmission timing of the first transmission signal is different from a transmission timing of the second transmission signal in at least one of the first transmission period and the second transmission period.

In one non-limiting and exemplary embodiment of the present disclosure, the first radar circuitry transmits the first transmission signal from a plurality of first transmission antennas, the second radar circuitry transmits the second transmission signal from a plurality of second transmission antennas, and a pattern of a Doppler shift amount applied to the first transmission signal transmitted from each of the plurality of first transmission antennas is different from a pattern of a Doppler shift amount applied to the second transmission signal transmitted from each of the plurality of second transmission antennas.

In one non-limiting and exemplary embodiment of the present disclosure, one radar circuitry of the first radar circuitry and the second radar circuitry demultiplexes a first reflected wave signal from a reception signal in the first transmission period, the first reflected wave signal corresponding to a transmission signal of the first transmission signal and the second transmission signal which is transmitted from the one radar circuitry, demultiplexes a second reflected wave signal and a third reflected wave signal from a reception signal in the second transmission period based on the first reflected wave signal, the second reflected wave signal corresponding to the transmission signal transmitted from the one radar circuitry, the third reflected wave signal corresponding to a transmission signal of the first transmission signal and the second transmission signal which is transmitted from other radar circuitry, determines aliasing of a Doppler frequency based on the first reflected wave signal and the second reflected wave signal, performs first angle measurement based on the determination of the aliasing, and performs second angle measurement based on the third reflected wave signal.

In one non-limiting and exemplary embodiment of the present disclosure, radar circuitry of the first radar circuitry and the second radar circuitry for which a center frequency of a transmission signal is the same between the first transmission period and the second transmission period determines the aliasing based on a phase difference between the first reflected wave signal and the second reflected wave signal.

In one non-limiting and exemplary embodiment of the present disclosure, radar circuitry of the first radar circuitry and the second radar circuitry for which a center frequency of a transmission signal is different between the first transmission period and the second transmission period determines the aliasing based on a difference in Doppler frequency between the first reflected wave signal and the second reflected wave signal.

In one non-limiting and exemplary embodiment of the present disclosure, a plurality of the second transmission periods consecutive to each other are configured after the first transmission period in the plurality of transmission periods, the first radar circuitry and the second radar circuitry determine the aliasing based on a phase difference between the second reflected wave signals in the plurality of second transmission periods, and determine the aliasing based on a phase difference between the third reflected wave signals in the plurality of second transmission periods.

In one non-limiting and exemplary embodiment of the present disclosure, a plurality of the first transmission periods consecutive to each other are configured in the plurality of transmission periods, at least one of the second transmission period is configured after the plurality of first transmission periods, and the first radar circuitry and the second radar circuitry determine the aliasing based on a phase difference between the third reflected wave signal and the first reflected wave signal in a transmission period from among the plurality of first transmission periods in which a center frequency identical to a center frequency of a transmission signal in the second transmission period is set.

A transmission method according to one non-limiting and exemplary embodiment of the present disclosure is a transmission method for a radar apparatus including first radar circuitry, which, in operation, transmits a first transmission signal; and second radar circuitry, which, in operation, transmits a second transmission signal, in which a plurality of transmission periods in which the first transmission signal and the second transmission signal are transmitted include a first transmission period in which frequency-division multiplexing transmission of the first transmission signal and the second transmission signal is performed, and a second transmission period in which the first transmission signal and the second transmission signal are transmitted at a same frequency.

While various embodiments have been described herein above, it is to be appreciated that various changes in form and detail may be made without departing from the sprit and scope of the disclosure(s) presently or hereafter claimed.

This application is entitled and claims the benefit of Japanese Patent Application No. 2023-138294, filed on Aug. 28, 2023, the disclosure of which including the specification, drawings and abstract is incorporated herein by reference in its entirety.

### INDUSTRIAL APPLICABILITY

The present disclosure is suitable as a radar apparatus for wide-angle range sensing.

### REFERENCE SIGNS LIST

1 Radar apparatus
10 Radar section
20, 20a Synchronizer
30 Integrator
100 Transmitter
101 Doppler shifter
102 Transmission antenna
200, 200a Receiver
201 System processor
202 Reception antenna
203 Reception radio
204 Mixer
205 LPF
206 Analyzer
207 A/D converter
208 Beat analyzer
209 Doppler analyzer
210 CFAR section
211 Demultiplexer
212 Determiner
213 Angle measurer
301 Generator
302 Modulation signal generator
303 VCO
304 Controller
305 Delayer
306 Switch

1. A radar apparatus, comprising:
first radar circuitry, which, in operation, transmits a first transmission signal; and
second radar circuitry, which, in operation, transmits a second transmission signal; wherein
a plurality of transmission periods in which the first transmission signal and the second transmission signal are transmitted include a first transmission period in which frequency-division multiplexing transmission of the first transmission signal and the second transmission signal is performed, and a second transmission period in which the first transmission signal and the second transmission signal are transmitted at a same frequency.

2. The radar apparatus according to claim 1, wherein
the first transmission period and the second transmission period are alternately configured in the plurality of transmission periods.

3. The radar apparatus according to claim 1, wherein
a plurality of the second transmission periods consecutive to each other are configured after the first transmission period in the plurality of transmission periods.

4. The radar apparatus according to claim 3, wherein
a center frequency of a transmission signal in each of the plurality of second transmission periods is different.

5. The radar apparatus according to claim 4, wherein
the center frequency of the transmission signal in each of the plurality of second transmission periods is identical to any of center frequencies set for the frequency-division multiplexing transmission in the first transmission period.

6. The radar apparatus according to claim 1, wherein:
a plurality of the first transmission periods consecutive to each other are configured in the plurality of transmission periods,
at least one of the second transmission periods is configured after the plurality of first transmission periods, and
a center frequency of a transmission signal of each of the plurality of first transmission periods is different for each of the first radar circuitry and the second radar circuitry.

7. The radar apparatus according to claim 6, wherein
a center frequency of a transmission signal in at least one transmission period of the plurality of first transmission periods is identical to a center frequency of a transmission signal in the second transmission period for at least one of the first radar circuitry and the second radar circuitry.

8. The radar apparatus according to claim 1, wherein
a transmission timing of the first transmission signal is different from a transmission timing of the second transmission signal in at least one of the first transmission period and the second transmission period.

9. The radar apparatus according to claim 1, wherein:
the first radar circuitry transmits the first transmission signal from a plurality of first transmission antennas,
the second radar circuitry transmits the second transmission signal from a plurality of second transmission antennas, and
a pattern of a Doppler shift amount applied to the first transmission signal transmitted from each of the plurality of first transmission antennas is different from a pattern of a Doppler shift amount applied to the second transmission signal transmitted from each of the plurality of second transmission antennas.

10. The radar apparatus according to claim 1, wherein:
one radar circuitry of the first radar circuitry and the second radar circuitry is operative to:
demultiplex a first reflected wave signal from a reception signal in the first transmission period, the first reflected wave signal corresponding to a transmission signal of the first transmission signal and the second transmission signal which is transmitted from the one radar circuitry,
demultiplex a second reflected wave signal and a third reflected wave signal from a reception signal in the second transmission period based on the first reflected wave signal, the second reflected wave signal corresponding to the transmission signal transmitted from the one radar circuitry, the third reflected wave signal corresponding to a transmission signal of the first transmission signal and the second transmission signal which is transmitted from other radar circuitry,
determine aliasing of a Doppler frequency based on the first reflected wave signal and the second reflected wave signal,
perform first angle measurement based on the determination of the aliasing, and
performs second angle measurement based on the third reflected wave signal.

11. The radar apparatus according to claim 10, wherein
radar circuitry of the first radar circuitry and the second radar circuitry for which a center frequency of a transmission signal is the same between the first transmission period and the second transmission period determines the aliasing based on a phase difference between the first reflected wave signal and the second reflected wave signal.

12. The radar apparatus according to claim 10, wherein
radar circuitry of the first radar circuitry and the second radar circuitry for which a center frequency of a transmission signal is different between the first transmission period and the second transmission period determines the aliasing based on a difference in Doppler frequency between the first reflected wave signal and the second reflected wave signal.

13. The radar apparatus according to claim 10, wherein:
a plurality of the second transmission periods consecutive to each other are configured after the first transmission period in the plurality of transmission periods,
the first radar circuitry and the second radar circuitry are operative to:
determine the aliasing based on a phase difference between the second reflected wave signals in the plurality of second transmission periods, and
determine the aliasing based on a phase difference between the third reflected wave signals in the plurality of second transmission periods.

14. The radar apparatus according to claim 10, wherein:
a plurality of the first transmission periods consecutive to each other are configured in the plurality of transmission periods,
at least one of the second transmission period is configured after the plurality of first transmission periods, and
the first radar circuitry and the second radar circuitry determine the aliasing based on a phase difference between the third reflected wave signal and the first reflected wave signal in a transmission period from among the plurality of first transmission periods in which a center frequency identical to a center frequency of a transmission signal in the second transmission period is set.

15. Radar signal generation circuitry, which, in operation, generates a first transmission signal transmitted from first radar circuitry and a second transmission signal transmitted from second radar circuitry, wherein
a plurality of transmission periods in which the first transmission signal and the second transmission signal are transmitted include a first transmission period in which frequency-division multiplexing transmission of the first transmission signal and the second transmission signal is performed, and a second transmission period in which the first transmission signal and the second transmission signal are transmitted at a same frequency.

16. The radar signal generation circuitry according to claim 15, wherein
the first transmission period and the second transmission period are alternately configured in the plurality of transmission periods.

17. The radar signal generation circuitry according to claim 15, wherein
a plurality of the second transmission periods consecutive to each other are configured after the first transmission period in the plurality of transmission periods.

18. A transmission method for a radar apparatus including first radar circuitry, which, in operation, transmits a first transmission signal, and second radar circuitry, which, in operation, transmits a second transmission signal, wherein
a plurality of transmission periods in which the first transmission signal and the second transmission signal are transmitted include a first transmission period in which frequency-division multiplexing transmission of the first transmission signal and the second transmission signal is performed, and a second transmission period in which the first transmission signal and the second transmission signal are transmitted at a same frequency.

19. The transmission method for the radar apparatus according to claim 18, wherein
the first transmission period and the second transmission period are alternately configured in the plurality of transmission periods.

20. The transmission method for the radar apparatus according to claim 18, wherein
a plurality of the second transmission periods consecutive to each other are configured after the first transmission period in the plurality of transmission periods.
